(19) United States
(12) Patent Application Publication
(10) Pub. No.: US 2020/0278631 A1
(43) Pub. Date: Sep. 3, 2020

(54) HEATER AND IMAGE FORMING APPARATUS

(71) Applicants: TOSHIBA TEC KABUSHIKI KAISHA, Tokyo (JP); TOSHIBA HOKUTO ELECTRONICS CORPORATION, Hokkaido (JP)

(72) Inventor: Masao ANDO, Tokyo (JP)

(21) Appl. No.: 16/880,371

(22) Filed: May 21, 2020

Related U.S. Application Data
(63) Continuation of application No. 15/624,990, filed on Jun. 16, 2017.

(30) Foreign Application Priority Data
Jun. 20, 2016 (JP) 2016-122177
May 16, 2017 (JP) 2017-097533

(51) Int. Cl. G03G 15/20

(52) U.S. Cl. CPC G03G 15/2053; G03G 15/80; G03G 15/2057; G03G 15/2042

(57) ABSTRACT

According to one embodiment, a heater has a base member, a heat generating resistor, a wiring and a switch. Three or more electrodes are disposed on the base member to be spaced apart from each other in a longitudinal direction of the base member. The heat generating resistor electrically interconnects electrodes which form an electrode pair and face each other in the longitudinal direction among the electrodes. The wiring connects the electrodes forming the electrode pair to have different polarities from each other. The switch is connected to the wiring and configured to select an electrode to which a voltage is to be applied.

### CROSS-REFERENCE TO RELATED APPLICATIONS

This application is a continuation of U.S. patent application Ser. No. 15/624,990, filed on Jun. 16, 2017, which claims priority from Japanese Patent Application No. 2016-122177 filed on Jun. 20, 2016, and Japanese Patent Application No. 2017-097533 filed on May 16, 2017, the contents of each of which are incorporated herein by reference in their entirety.

### FIELD

Embodiments of the present invention relate to a heater and an image forming apparatus.

### BACKGROUND

An image forming apparatus has a fixing device. The fixing device thermally fixes toner on a sheet. The fixing device has a fixing roller or fixing belt and a heat source.

When the size of a sheet being passed therethrough is switched to a larger size, for example, a temperature distribution on the fixing roller or fixing belt is not immediately eliminated. After the sheet size is switched, the fixing is performed in a state in which unevenness of the temperature distribution is large.

When a small sheet is consecutively passed therethrough, a state in which the fixing roller or the fixing belt is heated to a high temperature continues in a portion that is not in contact with the sheet.

Such unevenness in temperature distribution degrades a fixing quality. Particularly, in the case of color printing, unevenness in color formation and in gloss may occur in the fixed image.

### BRIEF DESCRIPTION OF THE DRAWINGS

FIG. 1 is a schematic cross-sectional view showing a configuration example of an image forming apparatus according to a first embodiment.

FIG. 2 is an enlarged schematic cross-sectional view showing a portion of an image forming unit according to the first embodiment.

FIG. 3 is a schematic cross-sectional view showing a configuration example of a main part of a fixing device including a heater according to the first embodiment.

FIG. 4 is a schematic cross-sectional view in a longitudinal direction showing a configuration example of a heater according to the first embodiment.

FIG. 5 is a schematic plan view showing a configuration example of a heater according to the first embodiment.

FIG. 6 is a block diagram showing a configuration example of a control system of an image forming apparatus according to the first embodiment.

FIG. 7 is a flowchart showing an operation example of an image forming apparatus according to the first embodiment at the time of printing.

FIG. 8 is a flowchart showing an operation example of fixing temperature control of an image forming apparatus according to the first embodiment.

FIG. 9 is a schematic plan view showing a control operation example of a heater according to the first embodiment.

FIG. 10 is a schematic plan view showing a control operation example of a heater of a comparative example.

FIG. 11 is a block diagram showing a configuration example of a control system of an image forming apparatus according to a second embodiment.

FIG. 12 is a schematic cross-sectional view in a longitudinal direction showing a configuration example of a heater according to the second embodiment.

FIG. 13 is a schematic plan view showing a configuration example of a heater according to the second embodiment.

FIG. 14 is a flowchart showing an operation example of fixing temperature control of an image forming apparatus according to the second embodiment.

FIG. 15 is a schematic cross-sectional view showing a configuration example of a main part of a heater according to a third embodiment.

FIG. 16 is a schematic plan view showing a configuration example of a heater according to a fourth embodiment.

FIG. 17 is a schematic plan view showing a configuration example of a heater according to a fifth embodiment.

FIG. 18 is a schematic cross-sectional view showing a configuration example of a heater according to a sixth embodiment.

### DETAILED DESCRIPTION

According to one embodiment, a heater has a base member, a heat generating resistor, a wiring and a switch. Three or more electrodes are disposed on the base member to be spaced apart from each other in a longitudinal direction of the base member. The heat generating resistor electrically interconnects electrodes which form an electrode pair and face each other in the longitudinal direction among the electrodes. The wiring connects the electrodes forming the electrode pair to have different polarities from each other. The switch is connected to the wiring and configured to select an electrode to which a voltage is to be applied.

Hereinafter, a heater and an image forming apparatus of embodiments will be described with reference to the drawings. In each of the drawings, the same components are designated by the same reference characters.

### First Embodiment

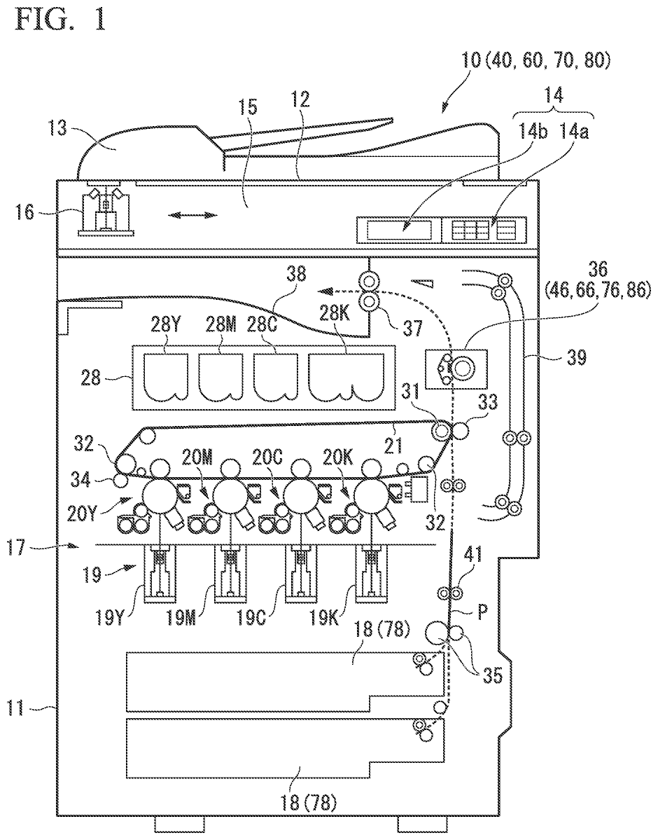

FIG. 1 is a schematic cross-sectional view showing a configuration example of an image forming apparatus according to a first embodiment. In FIG. 1, a dimension and a shape of each member are exaggerated or simplified for easier viewing (the same applies to subsequent drawings).

An image forming apparatus 10 according to the first embodiment shown in FIG. 1 is, for example, a multi-function peripheral (MFP) which is a multi-function copier, a printer, a copier, or the like. In the following description, an MFP will be described as an example.

A document table 12 including transparent glass is provided on an upper portion of a main body 11 of the image forming apparatus 10. An automatic document feeder (ADF) 13 is provided on the document table 12. A manipulation panel 14 is provided on the upper portion of the main body 11. The manipulation panel 14 includes an operation panel 14a having various keys and a touch panel type display 14b.

A scanner 15 serving as a reading device is provided under the ADF 13. The scanner 15 reads a document sent by the ADF 13 or a document placed on the document table 12. The scanner 15 generates image data of the document. The scanner 15 has an image sensor 16, for example. The image sensor 16 may be a contact type image sensor. The image sensor 16 is disposed in a main scanning direction (a depth direction in FIG. 1).

The image sensor 16 is configured to move along the document table 12 when it reads an image of the document placed on the document table 12. The image sensor 16 is configured to read one page of the document image line by line.

When the image sensor 16 reads the image of the document sent by the ADF 13, the image sensor 16 is configured to read the received document at a fixed position shown in FIG. 1.

The main body 11 of the image forming apparatus 10 has a printer 17 at a center portion in a height direction. The main body 11 has a plurality of paper feeding cassettes 18 which accommodate a sheet P (paper) of any of various sizes at a lower portion thereof.

The paper feeding cassettes 18 are configured to accommodate the sheet P of any of various sizes on a central reference. A central axis of the width of the sheet P of any of various sizes in a direction perpendicular to a conveying direction is aligned at a normal position.

Hereinafter, a direction perpendicular to the conveying direction of the sheet P along a conveying surface of the sheet P in the image forming apparatus 10 is referred to as “a conveyance perpendicular direction.”

The printer 17 has a photosensitive drum and an exposure unit 19.

The printer 17 is configured to form an image on the sheet P according to image data read by the scanner 15 or according to image data created by a personal computer or the like. The printer 17 is a tandem type color printer, for example.

The printer 17 has image forming units 20Y, 20M, 20C, and 20K of respective colors yellow (Y), magenta (M), cyan (C), and black (K). The image forming units 20Y, 20M, 20C, and 20K are disposed at a lower side of an intermediate transfer belt 21. The image forming units 20Y, 20M, 20C, and 20K are disposed in parallel from upstream to downstream in a moving direction (a direction from the left side to the right side in the drawing) of the lower side of the intermediate transfer belt 21.

The exposure unit 19 has exposure units 19Y, 19M, 19C, and 19K corresponding to the image forming units 20Y, 20M, 20C, and 20K, respectively.

The exposure unit 19 may be an exposure unit using laser scanning or an exposure unit using a solid scanning device such as a light emitting diode (LED). When the laser scanning is used as the exposure unit, a deflector may be commonly used between a plurality of exposure units when each of the exposure units 19Y, 19M, 19C, and 19K has a different laser light source.

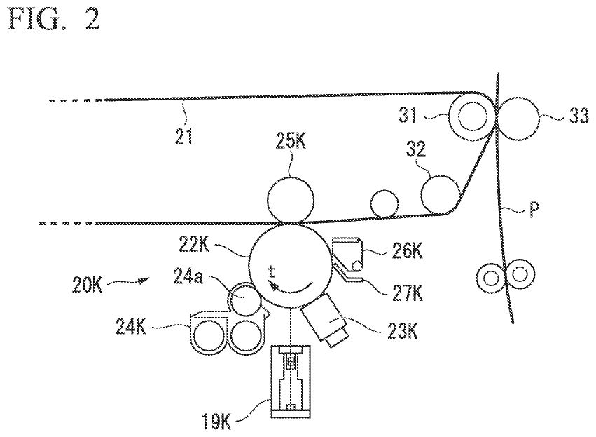

FIG. 2 is a schematic view showing an enlarged cross section of the image forming unit 20K among the image forming units 20Y, 20M, 20C, and 20K.

Configurations of the respective image forming units 20Y, 20M, 20C, and 20K are different merely in toner. Hereinafter, components common to the image forming units 20Y, 20M, 20C, and 20K will be described with reference to an example of the image forming unit 20K.

As shown in FIG. 2, the image forming unit 20K has a photosensitive drum 22K serving as an image carrier. A charger 23K, a developer 24K, a primary transfer roller 25K, a cleaner 26K, a blade 27K, and the like are disposed around the photosensitive drum 22K in a rotation direction t.

The charger 23K of the image forming unit 20K uniformly charges a surface of the photosensitive drum 22K.

The exposure unit 19K is configured to irradiate the surface of the photosensitive drum 22K with light modulated according to the image data. The exposure unit 19K is configured to form an electrostatic latent image on the photosensitive drum 22K.

The developer 24K is configured to supply black toner to the photosensitive drum 22K by a developing roller 24a to which a developing bias is applied. The developer 24K is configured to develop the electrostatic latent image on the photosensitive drum 22K.

The cleaner 26K has the blade 27K that comes into contact with the photosensitive drum 22K. The blade 27K is configured to remove residual toner on the surface of the photosensitive drum 22K.

As shown in FIG. 1, a toner cartridge 28 is disposed above the image forming units 20Y, 20M, 20C, and 20K.

The toner cartridge 28 is configured to supply the toner to each of the developers 24Y, 24M, 24C, and 24K. The toner cartridge 28 includes toner cartridges 28Y, 28M, 28C, and 28K which respectively contain toners of yellow (Y), magenta (M), cyan (C), and black (K).

The intermediate transfer belt 21 is configured to move circularly. The intermediate transfer belt 21 is stretched over a drive roller 31 and a plurality of driven rollers 32 (refer to FIG. 1). The intermediate transfer belt 21 comes into contact with the photosensitive drums 22Y, 22M, 22C, and 22K from an upper side as in the drawing.

For example, as shown in FIG. 2, in the intermediate transfer belt 21, the primary transfer roller 25K is disposed at an inner side of the intermediate transfer belt 21 at a position facing the photosensitive drum 22K.

When a primary transfer voltage is applied, the primary transfer roller 25K primarily transfers a toner image on the photosensitive drum 22K to the intermediate transfer belt 21.

As shown in FIG. 1, a secondary transfer roller 33 faces the drive roller 31 with the intermediate transfer belt 21 interposed therebetween.

A secondary transfer voltage is applied to the secondary transfer roller 33 when the sheet P passes through a secondary transfer position between the drive roller 31 and the secondary transfer roller 33. When the secondary transfer voltage is applied, the secondary transfer roller 33 secondarily transfers the toner image on the intermediate transfer belt 21 to the sheet P.

A belt cleaner 34 is disposed near the driven rollers 32 on the left side in the drawing. The belt cleaner 34 removes a residual transfer toner on the intermediate transfer belt 21 from the intermediate transfer belt 21.

As shown in FIG. 1, a paper feeding roller 35 is provided between the paper feeding cassettes 18 and the secondary transfer roller 33. The paper feeding roller 35 is configured to convey the sheet P taken out from the inside of the paper feeding cassettes 18.

A fixing device 36 is disposed downstream (an upper side in the drawing) of the secondary transfer roller 33 in the conveying direction of the sheet P.

A conveyance roller 37 is disposed downstream of the fixing device 36 (an upper left side in the drawing) in the conveying direction of the sheet P. The conveyance roller 37 is configured to discharge the sheet P to a sheet discharger 38.

A reverse conveying path 39 is disposed downstream of the fixing device 36 (the right side in the drawing) in the conveying direction of the sheet P. The reverse conveying path 39 is configured to reverse the sheet P and guides it toward the secondary transfer roller 33. The reverse conveying path 39 is used when double-sided printing is performed.

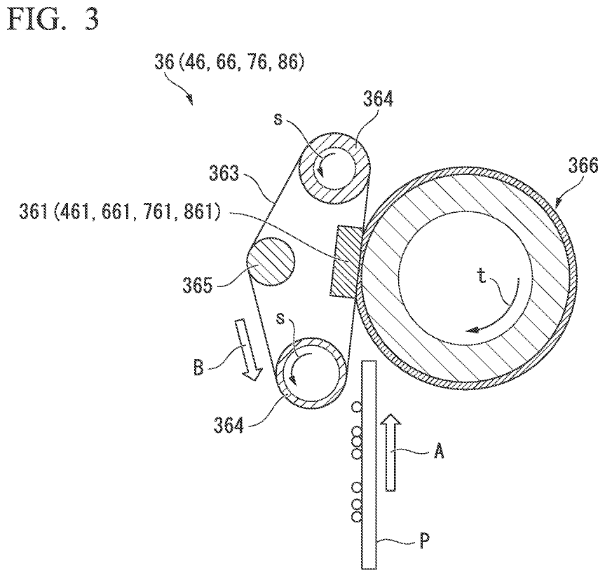

FIG. 3 is a schematic cross-sectional view showing a configuration example of a main part of the fixing device 36.

As shown in FIG. 3, the fixing device 36 has a fixing belt 363, a press roller 366, belt conveying rollers 364, a tension roller 365, and a heating member 361 (a heater).

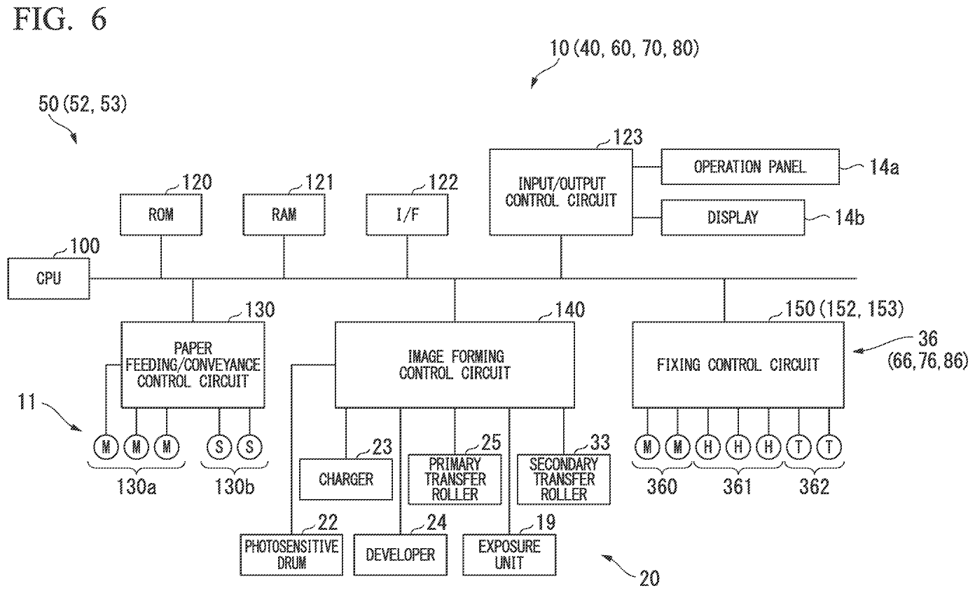

Although not shown in FIG. 3, the fixing device 36 further has a temperature detector 362 (refer to FIG. 6) as will be described below.

The fixing belt 363 is an endless belt. The fixing belt 363 has an elastic layer on its surface. The fixing belt 363 faces the press roller 366.

The press roller 366 has an elastic layer on the surface thereof. The press roller 366 is rotatably supported in a rotation direction t as in the drawing.

The fixing belt 363 and the press roller 366 have a width (a width in the conveyance perpendicular direction of the sheet P) larger than a maximum sheet width that can be passed in the image forming apparatus 10.

The fixing belt 363 is pressed against a surface of the press roller 366. A contact portion between the fixing belt 363 and the press roller 366 form a fixing nip. The fixing nip is slightly longer than the maximum sheet width that can be passed through. The width of the fixing nip in a conveying direction A of the sheet P is set to a predetermined width. The predetermined width is a width to which an amount of heat for thermally fixing the toner image that has been transferred to the sheet P can be supplied.

The tension roller 365 and two belt conveying rollers 364 are disposed inside the fixing belt 363. The fixing belt 363 is stretched from the inside by the tension roller 365 and the two belt conveying rollers 364.

The tension roller 365 presses an inside of the fixing belt 363 at a position at which a contact portion of the fixing belt 363 and the press roller 366 is sandwiched therebetween. The tension roller 365 provides tension to the fixing belt 363.

The belt conveying rollers 364 are configured to be rotationally driven counterclockwise as in the drawing (refer to the arrow s) by a driving motor (not shown in the figure). When the belt conveying rollers 364 rotate, the fixing belt 363 is rotationally driven counterclockwise as represented by an arrow B as in the drawing.

The heating member 361 is configured to heat the sheet P via the fixing belt 363 at the fixing nip.

A main part of the heating member 361 is formed in a plate shape. The heating member 361 has a heat generating portion on one surface in a plate thickness direction. The heat generating portion of the heating member 361 is in contact with an inner side of the fixing belt 363 on a back side of the fixing nip. The heating member 361 is disposed such that the longitudinal direction thereof follows a longitudinal direction of the fixing nip.

The heating member 361 is pressed toward the press roller 366 by a pressing member (not shown in the figure). Since the heating member 361 presses the fixing belt 363 to the press roller 366, the width of the fixing nip in the conveying direction is maintained at a predetermined width.

Heat generated in the heat generating portion of the heating member 361 is thermally conducted in a thickness direction of the fixing belt 363. The heat thermally conducted to the fixing belt 363 is also thermally conducted to the press roller 366 at a portion of the fixing nip. When the sheet P passes through the fixing nip, the sheet P is heated at the fixing nip.

The heating member 361 heats the fixing nip by thermal conduction via the fixing belt 363. Therefore, in the fixing device 36, temperature responsiveness of the fixing nip is excellent compared to the case of a heating method using radiation such as a halogen lamp.

A configuration example of the heating member 361 will be described in detail.

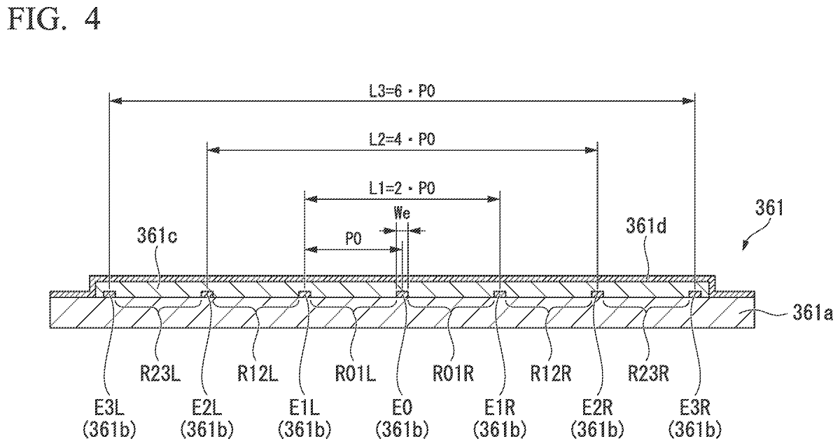

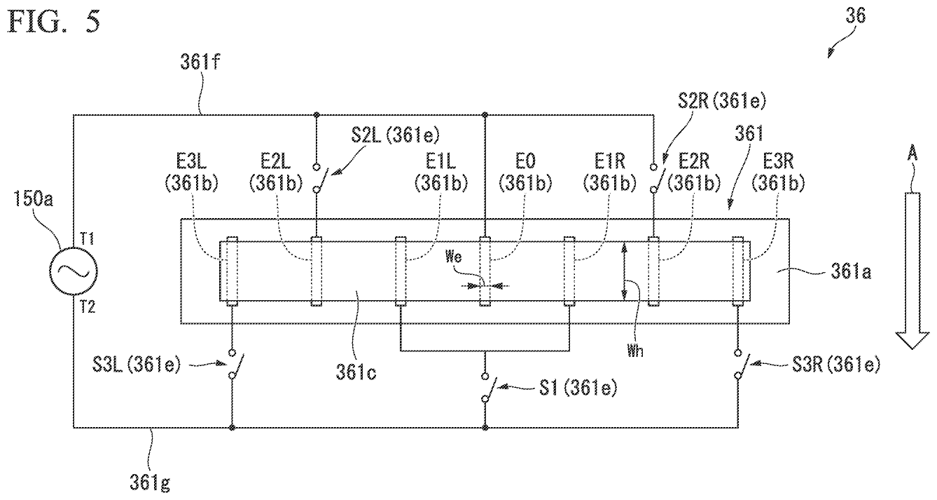

FIG. 4 is a schematic cross-sectional view in a longitudinal direction showing a configuration example of the heating member 361 according to the first embodiment. FIG. 5 is a schematic plan view showing a configuration example of the heating member 361 according to the first embodiment. However, in FIG. 5, a surface protective layer 361d to be described below is omitted for easier viewing in the drawing.

As shown in FIG. 4, the heating member 361 has a base member 361a, an electrode 361b, a heat generating resistor 361c, and the surface protective layer 361d. As shown in FIG. 5, the heating member 361 further has wirings 361f and 361g and a switch 361e.

As shown in FIG. 4, the base member 361a includes a ceramic substrate, for example. A glaze layer (not shown in the figure) is laminated on one surface in a plate thickness direction of the ceramic substrate (a surface of an upper side in the drawing).

A heat sink (not shown in the figure) configured to dissipate extra heat of the heat generating portion may be attached to the other surface in the plate thickness direction of the ceramic substrate. The heat sink may be made of an aluminum alloy. When the heat sink is attached to the ceramic substrate, the heat sink also functions to prevent a warp of the ceramic substrate.

The electrode 361b applies a voltage to the heat generating resistor 361c to be described below. When paper conveyance is on the central reference, five or more electrodes 361b are provided on the glaze layer (not shown in the figure) of the base member 361a.

In the configuration examples shown in FIGS. 4 and 5, the electrode 361b is constituted with seven electrodes, including an electrode E0 (a central electrode) and electrodes E1L, E2L, E3L, E1R, E2R, and E3R.

As shown in FIG. 5, the electrode E0 is formed in a linear shape and extends in a short direction perpendicular to a longitudinal direction of the base member 361a. The line width of the electrode E0 is We. It is preferable that the line width We be thin. The line width We may be in a range of 0.5 to 3.0 mm, for example.

The electrode E0 is disposed at a center portion in the longitudinal direction of the base member 361a. In the fixing device 36, the longitudinal direction of the base member 361a is aligned with the conveyance perpendicular direction. The position of the electrode E0 in the longitudinal direction of the base member 361a is aligned with a center of the conveying path in the conveyance perpendicular direction of the fixing device 36.

Each electrode 361b is formed of a metal having a high degree of conductivity. Each electrode 361b may be formed of a metal such as aluminum or copper, for example.

As shown in FIG. 4, on the left side of the electrode E0 in the drawing, the electrodes E1L, E2L, and E3L are disposed in that order at a pitch P0 from the center toward a left end as in the drawing in the conveyance perpendicular direction.

On the right side of the electrode E0 in the drawing, the electrodes E1R, E2R, and E3R are disposed in that order at the pitch P0 from the center toward a right end shown in the drawing in the conveyance perpendicular direction.

As described above, the seven electrodes 361b in the embodiment are disposed to be line-symmetrical with respect to a center line of the line width of the electrode E0 as the axis of symmetry.

As shown in FIG. 5, a shape of the electrodes E1L, E2L, E3L E1R, E2R, and E3R in a plan view is the same as that of the electrode E0. All the electrodes E1L, E2L, E3L, E1R, E2R, and E3R are disposed in parallel with the electrode E0. The position of the electrodes E1L, E2L, E3L, E1R, E2R, and E3R in a short direction of the base member 361a may be different from that of the electrode E0. However, the electrodes E0, E1L, E2L, E3L, E1R, E2R, and E3R extend in the longitudinal direction of the base member 361a and are formed at positions and with lengths that can traverse rectangular regions having a width Wh in the short direction.

The wiring 361f electrically connects each end of the electrodes E2L, E0, and E2R in the longitudinal direction thereof (the short direction of the base member 361a) to a fixing power source 150a to be described below.

The wiring 361g electrically connects each end of the electrodes E3L, E1L, E1R, and E3R in the longitudinal direction thereof (the short direction of the base member 361a) to the fixing power source 150a to be described below.

The fixing power source 150a is an alternating current (AC) power source. In the fixing power source 150a, an AC voltage oscillating at an amplitude V and a frequency f is applied between a terminal T1 (a first terminal) and a terminal T2 (a second terminal). The terminals T1 and T2 have polarities opposite to each other.

The fixing power source 150a may be disposed at any position in the image forming apparatus 10. In the embodiment, the fixing power source 150a is provided as a part of a fixing control circuit 150 to be described below as an example.

The electrodes E0, E2L, and E2R are wired to the terminal T1 of the fixing power source 150a by the wiring 361f. The electrodes E1L, E1R, E3L and E3R are wired to the terminal T2 of the fixing power source 150a by the wiring 361g.

The switch 361e is provided between the fixing power source 150a and the electrode 361b on the wirings 361f and 361g. The switch 361e selects the electrode 361b to which a voltage is applied by the fixing power source 150a.

The switch 361e includes switches S2L, S2R, S1, S3L, and S3R.

The electrode E0 is always electrically connected to the terminal T1 by the wiring 361f.

The electrodes E2L and E2R are connected to the terminal T1 respectively via the switches S2L and S2R. The switch S2L (S2R) can turn on (ON) or turn off (OFF) the electrical connection between the electrode E2L (E2R) and the terminal T1.

The electrodes E1L and E1R are connected to the terminal T2 via the switch S1. The switch S1 can turn on or turn off the electrical connection between the electrodes E1L and E1R and the terminal T2.

The electrodes E3L and E3R are connected to the terminal T2 respectively via the switches S3L and S3R. The switch S3L (S3R) can turn on or turn off the electrical connection between the electrode E3L (E3R) and the terminal T2.

A switching operation of each switch 361e is individually controlled by the fixing control circuit 150 to be described below.

Specific examples of each switch 361e include a switching device, a field-effect transistor (FET), a triac, a switching integrated circuit (IC), and the like.

Each switch 361e may be provided at any position of the wirings 361f and 361g as long as the above-described electrical connection is possible.

Each switch 361e may be integrated with a member disposed in the fixing device 36 such as the base member 361a, for example. Each switch 361e may be provided on the wirings 361f and 361g extending to the outside of the fixing device 36, for example. Each switch 361e may be disposed inside the image forming apparatus 10 in which the fixing power source 150a is disposed.

According to such wirings, when each switch 361e is turned on, the electrodes E3L, E2L, E1L, E0, E1R, E2R, and E3R are electrically connected respectively to the terminals T2, T1, T2, T1, T2, T1, and T2. Electrode pairs facing each other in the longitudinal direction of the base member 361a (the electrodes E3L and E2L, the electrodes E2L and E1L, and the like, for example) are connected to the terminals having polarities opposite to each other.

As shown in FIG. 4, the heat generating resistor 361c is laminated on a surface of the base member 361a. The heat generating resistor 361c covers each electrode 361b. In the embodiment, the layer thickness of the heat generating resistor 361c is constant.

As shown in FIG. 5, the heat generating resistor 361c has a strip shape extending in the longitudinal direction of the base member 361a in a plan view. The width of the heat generating resistor 361c in the short direction is Wh in a plan view.

In a plan view, each electrode 361b traverses the heat generating resistor 361c in the short direction. Each electrode 361b is covered with the heat generating resistor 361c within a range of the width Wh.

The heat generating resistor 361c electrically interconnects the electrode pair facing each other in the longitudinal direction of the base member 361a among each of the electrodes.

As shown in FIG. 4, the electrode pair formed with the electrode E0 and the electrode E1 are electrically interconnected by the heat generating resistor 361c having a length of substantially P0 and the width Wh, for example. This also applies to the other electrode pairs facing each other in the longitudinal direction of the base member 361a.

The heat generating resistor 361c is formed of a material that generates Joule heat when an AC voltage is applied. As a material of the heat generating resistor 361c, a well-known material used to form a thermal head may be used. The heat generating resistor 361c may be formed of TaSiO₂ or the like, for example.

The surface protective layer 361d protects a surface of the heating member 361 which slides on an inner peripheral surface of the fixing belt 363. As shown in FIG. 5, the surface protective layer 361d is laminated on the base member 361a to cover at least a surface of the heat generating resistor 361c.

The surface protective layer 361d may be formed of Si₃N₄ or the like as an example. The material of the surface protective layer 361d is not limited to Si₃N₄.

The laminate of the heat generating resistor 361c and the surface protective layer 361d constitutes a heat generating portion of the heating member 361.

With such a configuration, when a voltage is applied to the electrode pair facing each other in the longitudinal direction of the heating member 361 by the fixing power source 150a, an AC current flows between the electrode pair to which the voltage is applied. The heat generating resistor 361c between the electrode pair to which the voltage is applied generates Joule heat.

As shown in FIG. 4, the heating member 361 has six heat generating regions R23L, R12L, R01L, R01R, R12R, and R23R formed with the heat generating resistor 361c sandwiched by the respective electrode pairs. Here, the heat generating region R23L is a region of the heat generating resistor 361c sandwiched by the electrode pair of the electrodes E2L and E3L.

The size of each heat generating region is determined by a disposition interval of each electrode pair. In the embodiment, since the electrode 361b is arranged at a regular pitch P0, the sizes of the respective heat generating regions are equal to each other.

Here, the pitch P0 is determined according to the sheet width of the sheet P that can be passed in the image forming apparatus 10.

For example, it is assumed that the sizes that can be passed in the image forming apparatus 10 are a postcard size (100 mm×148 mm), a compact disk (CD) jacket size (121 mm×121 mm), an A5R size (148 mm×210 mm), a B5R size (182 mm×257 mm), an A4R size (210 mm×297 mm), a B5 size (257 mm×182 mm), an A4 size (297 mm×210 mm), and an A3R size (297 mm×420 mm). In this case, the sheet widths of each sheet P are 100 mm, 121 mm, 148 mm, 182 mm, 210 mm, 257 mm, 297 mm, and 297 mm, respectively.

For example, it is assumed that the arrangement pitch P0 of the respective electrodes 361b is 54.5 mm. At this time, a disposition interval L1 of the electrodes E1L and E1R is 109 mm, a disposition interval L2 of the electrodes E2L and E2R is 218 mm, and a disposition interval L3 of the electrodes E3L and E3R is 327 mm.

In this case, when heat is generated at the heat generating regions ROIL and R01R, it is possible to fix the sheet P of the postcard size. When heat is generated at the heat generating regions R12L, R01L, R01R, and R12R, it is possible to fix the sheet P of the CD jacket size, the A5R size, the B5R size, and A4R size. When heat is generated at the heat generating regions R23L, R12L, R01L, R01R, R12R, and R23R, it is possible to fix the sheet P of the B5 size, the A4 size, and A3R size.

The width of the heat generating region needed for fixing is set to have a margin in consideration of conveyance accuracy of the sheet P, skewing, and heat escape via a non-heated portion with respect to the sheet width. However, when an image forming width on the sheet P is smaller than the sheet width, the width of the heat generating region needed for fixing may be set to have the same margin as that of the image forming width.

Next, a configuration of a control system of the image forming apparatus 10 will be described.

FIG. 6 is a block diagram showing a configuration example of a control system 50 of the image forming apparatus 10 according to the first embodiment.

However, members distinguished by the suffixes Y, M, C, and K are represented by characters from which the subscripts are deleted in FIG. 6 for easier viewing. For example, a photosensitive drum 22 represents the photosensitive drums 22Y, 22M, 22C, and 22K. The same applies to a charger 23, a developer 24, a primary transfer roller 25, and an exposure unit 19.

As shown in FIG. 6, the control system 50 has a central processor (CPU) 100, a read-only memory (ROM) 120, a random-access memory (RAM) 121, an interface (I/F) 122, an input/output control circuit 123, a paper feeding/conveyance control circuit 130, an image forming control circuit 140, and a fixing control circuit 150 (a fixing controller).

The CPU 100 controls the entire image forming apparatus 10. The CPU 100 realizes a processing function to form an image by executing a program stored in the ROM 120 or the RAM 121.

The ROM 120 stores control programs, control data, and the like, which manage a basic operation of the image forming process. The RAM 121 is a working memory.

The ROM 120 (or the RAM 121) stores, for example, a control program which controls the image forming unit 20, the fixing device 36, and the like, and various control data used by the control program. As a specific example of the control data in the embodiment, a corresponding correlation between the size of the sheet P and the switch which selects the heat generating region of the heating member 361 to be heated is an exemplary example.

A fixing temperature control program which controls a temperature of the fixing device 36 includes a heating width determination logic and a heating control logic. The heating width determination logic detects the size of the sheet P on which the toner image is formed and determines a required heating width. The heating control logic selects a heat generating region corresponding to the required heating width and controls heating by the heating member 361.

The I/F 122 communicates with various devices such as a user terminal, a facsimile, or the like.

The input/output control circuit 123 controls the operation panel 14a and the display 14b.

The paper feeding/conveyance control circuit 130 controls a driving system included in the main body 11. For example, a motor group 130a which drives a paper feeding roller 35 (refer to FIG. 1) and a resist roller 41 (refer to FIG. 1) of the conveying path is included in the driving system. The paper feeding/conveyance control circuit 130 controls a driving system such as the motor group 130a according to a control signal from the CPU 100 and detection results of various sensors 130b near the paper feeding cassettes 18 (refer to FIG. 1) or according to the conveying path.

The image forming control circuit 140 controls the photosensitive drum 22, the charger 23, the exposure unit 19, the developer 24, the primary transfer roller 25, and the secondary transfer roller 33 according to the control signal from the CPU 100.

The fixing control circuit 150 controls a driving motor 360, the heating member 361, and the temperature detector 362 which are in the fixing device 36 according to the control signal from the CPU 100.

The temperature detector 362 directly or indirectly detects the temperature of the fixing belt 363 (refer to FIG. 3) which forms the fixing nip. A thermistor is one specific example of the temperature detector 362.

The temperature detector 362 may be disposed at an inner side or an outer side of the fixing belt 363. The temperature detector 362 may be disposed in the heat generating portion of the heating member 361 in contact with the fixing belt 363.

The number of temperature detectors 362 disposed is not limited. When one temperature detector 362 is disposed, it is disposed in a range corresponding to the width L1 (refer to FIG. 4) of the heating member 361, for example.

When a plurality of temperature detectors 362 are disposed, for example, one temperature detector 362 may be disposed in each of the heat generating regions of the heating member 361. The temperature distribution in the longitudinal direction of the heat generating portion of the heating member 361 is substantially symmetrical with respect to the electrode E0. Therefore, one temperature detector 362 may be disposed in each of the ranges corresponding to the heat generating regions R01L, R12L, and R23L, or in each of the ranges corresponding to the heat generating regions R01R, R12R, and R23R.

In the embodiment, the control program and the control data of the fixing device 36 are configured to be stored in the storage of the image forming apparatus 10 and are executed by the CPU 100; however a configuration in which an arithmetic processor and a storage are separately provided for exclusive use of the fixing device 36 is also acceptable.

Next, the following description will be based on an operation of the image forming apparatus 10 at the time of printing.

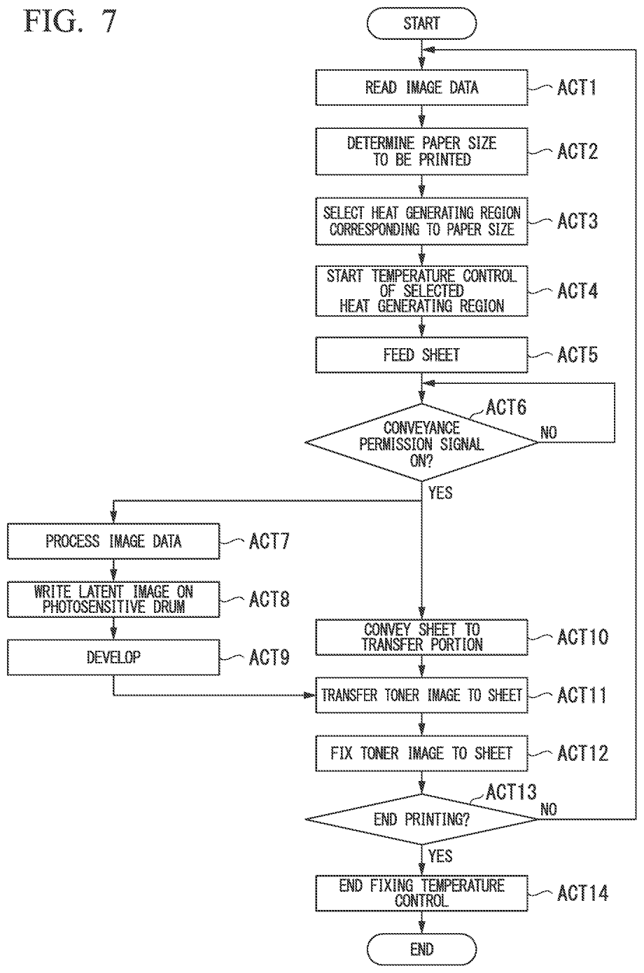

FIG. 7 is a flowchart showing an operation example of the image forming apparatus 10 according to the first embodiment at the time of printing.

The image forming apparatus 10 executes ACT 1 to ACT 14 shown in FIG. 7 in accordance with the flow shown in FIG. 7 to print an image on the sheet P.

In ACT 1, the image forming apparatus 10 reads image data. Reading of the image data may be performed by an operator operating the scanner 15 to make the scanner 15 read the document. Alternatively, the image data may be read through a communication line connected to the image forming apparatus 10 via the I/F 122.

After the image data is read, ACT 2 is executed.

In ACT 2, the CPU 100 determines the paper size to be printed. The CPU 100 determines the paper size of the sheet P to be used for printing according to a setting by the operation panel 14a, a document size detected by the scanner 15, or a control signal from an external device.

As a result, a sheet width of the sheet P passing through the fixing device 36 is determined.

Therefore, ACT 2 ends.

When ACT 2 ends, ACT 3 is performed. In ACT 3, the CPU 100 selects a heat generating region corresponding to the paper size.

The CPU 100 selects the heat generating region to be heated according to the correlation between the sheet width and the heat generating region.

In the ROM 120 of the embodiment, the correspondence between the paper size and the heat generating region to be selected is stored as follows, for example. In the case of the postcard size, the heat generating regions R01L and R01R are selected. In the case of the CD jacket size, the A5R size, the B5R size, and the A4R size, the heat generating regions R12L, R01L, R01R, and R12R are selected. In the case of the B5 size, the A4 size, and the A3R size, the heat generating regions R23L, R12L, R01L, R01R, R12R and R23R are selected.

In ACT 2, when the sheet P to be used for printing is determined as the postcard size, for example, the CPU 100 selects the heat generating regions R01L and R01R to be heated.

Therefore, ACT 3 ends.

After ACT 3, ACT 4 is performed. In ACT 4, the CPU 100 sends a control signal to start the fixing temperature control (referred to as a fixing temperature control start signal) to the fixing control circuit 150. The CPU 100 sends information on the selected heat generating region to the fixing control circuit 150 together with the fixing temperature control start signal.

The fixing temperature control by the fixing control circuit 150 is continuously performed until the CPU 100 sends a control signal for ending the fixing temperature control to the fixing control circuit 150.

When ACT 4 ends, ACT 5 is performed. In ACT 5, the CPU 100 sends the paper feeding/conveyance control circuit 130 a control signal for feeding the sheet P used for printing from the paper feeding cassettes 18.

The paper feeding/conveyance control circuit 130 performs the control of feeding the sheet P used for printing from the paper feeding cassettes 18 according to the control signal from the CPU 100. In addition, the paper feeding/conveyance control circuit 130 drives the paper feeding roller 35. The paper feeding roller 35 stops in a state in which a leading end of the sheet P is in contact with the resist roller 41.

Therefore, ACT 5 ends.

After ACT 5, ACT 6 is performed. Before describing ACT 6, the fixing temperature control by the fixing control circuit 150 will be described. The fixing temperature control is performed in parallel with each operation after ACT 6.

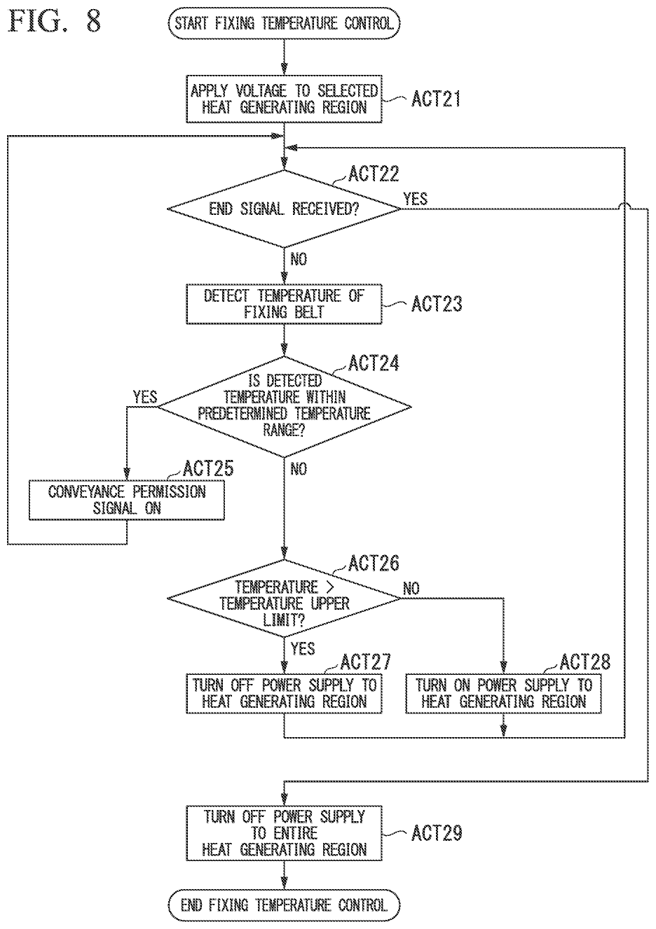

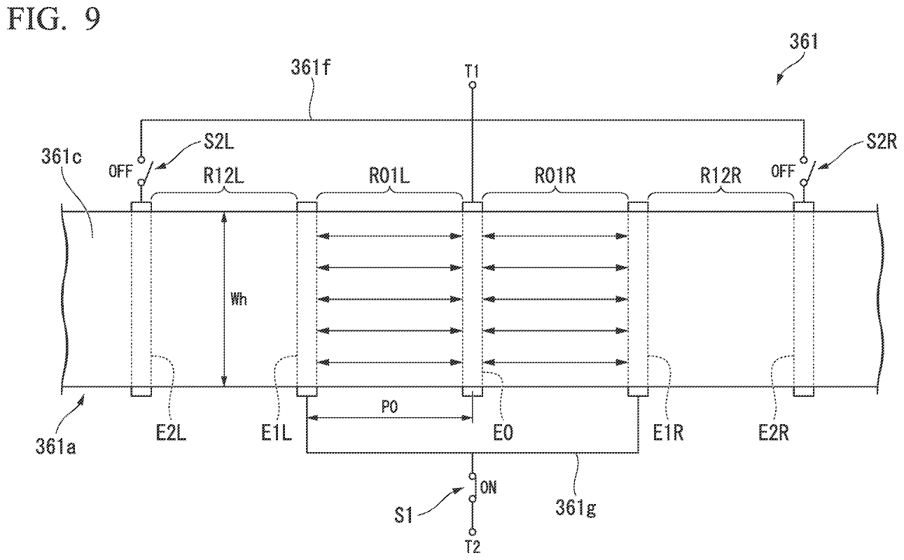

FIG. 8 is a flowchart showing an operation example of the fixing temperature control of the image forming apparatus 10 according to the first embodiment. FIG. 9 is a schematic plan view showing a control operation example of the heating member 361 according to the first embodiment.

The fixing control circuit 150 executes ACT 21 to ACT 29 shown in FIG. 8 in accordance with the flow shown in FIG. 8.

First, ACT 21 is performed. In ACT 21, the fixing control circuit 150 turns on the switch 361e connected to the electrode pair sandwiching the selected heat generating region according to the information of the heat generating region selected by the CPU 100 sent from the CPU 100.

When it is selected to heat the heat generating regions R01L and R01R, for example, the fixing control circuit 150 turns on the switch S1 among the switch 361e and turns off the other switch.

As shown in FIG. 9, the electrode E0 is electrically conducted to the terminal T1. When the switch S1 is turned on, the electrodes E1L and E1R are electrically conducted to the terminal T2. The electrodes E2L and E2R and the electrodes E3L and E3R (not shown in the figure) are not electrically conductive with the terminals T1 and T2, respectively.

A voltage corresponding to the potential difference between the terminals T1 and T2 is applied between the electrodes E0 and E1L and between the electrodes E0 and E1R. A current flows between the electrodes E0 and E1L and between the electrodes E0 and E1R in opposite directions to each other. This current flows in substantially a uniform amount in the width direction of the heat generating resistor 361c having the width Wh and the length P0.

Due to the Joule heat generated by this current, the heat generating resistor 361c of the heat generating regions ROIL and R01R starts to generate heat.

In the embodiment, the heat generating resistor 361c is laminated on the electrode E0 which is a boundary of the heat generating regions. Since the heat generating resistor 361c on the electrode E0 has low current density compared to the side of the electrode E0, an amount of heat generation thereof is reduced. However, the line width of the electrode E0 can be an extent of 0.5 mm or more and 3.0 mm or less. As a result, the heat generating resistor 361c on the electrode E0 immediately rises in temperature by thermal conduction from the surroundings.

On the other hand, no voltage is applied between the electrode pairs other than the electrodes E0 and E1L and the electrodes E0 and E1R. Heat generation does not occur in the heat generating regions R12L, R12R, R23L, and R23R.

The heat generating resistor 361c generates heat substantially uniformly in a rectangular range, whose center is the electrode E0, having the width Wh and the length L1 (=2·P0).

Similarly, when the heat generating regions R01L, R01R, R12L, and R12R are selected to be heated, the fixing control circuit 150 turns on the switches S1, S2L, and S2R among the switch 361e and turns off the switches S3L and S3R. The heat generating resistor 361c generates heat substantially uniformly in a rectangular range, whose center is the electrode E0, having a width Wh and a length L2 (=4·P0).

When the heat generating regions R01L, R01R, R12L, R12R, R23L, and R23R are selected to be heated, the fixing control circuit 150 turns all of the switch 361e on. The heat generating resistor 361c generates heat substantially uniformly in a rectangular range, whose center is the electrode E0, having a width Wh and a length L3 (=6·P0).

After ACT 21, ACT 22 is performed. In ACT 22, the fixing control circuit 150 determines whether or not a control signal (hereinafter referred to as a fixing temperature control end signal) for ending the fixing temperature control sent by the CPU 100 has been received.

When the fixing control circuit 150 receives the fixing temperature control end signal (ACT 22: YES), ACT 29 is performed.

When the fixing control circuit 150 has not received the fixing temperature control end signal (ACT 22: NO), ACT 23 is performed.

In ACT 23, the fixing control circuit 150 detects the temperature of the fixing belt 363 which forms the fixing nip using the temperature detector 362.

When the temperature detector 362 indirectly detects the temperature of the fixing belt 363, the fixing control circuit 150 converts the detected temperature into the temperature of the fixing nip of the fixing belt 363. For example, a correlation between the detected temperature by the temperature detector 362 and the temperature of the fixing nip is stored in the ROM 120 in advance as a conversion table or the like.

When a plurality of temperature detectors 362 are disposed, in ACT 23, the fixing control circuit 150 executes the following operations according to the temperature information by the temperature detectors 362 which detect the temperature of the selected heat generating region.

Therefore, ACT 23 ends.

After ACT 23, ACT 24 is performed. In ACT 24, the fixing control circuit 150 determines whether or not the temperature detected in ACT 23 (hereinafter referred to as a detected temperature) falls within a predetermined temperature range. When the fixing control circuit 150 obtains the detected temperature according to the detection signals of the plurality of temperature detectors 362, the determination is carried out according to the lowest detected temperature in the range corresponding to the selected heat generating region.

The predetermined temperature range is determined in advance as a temperature range to fix the toner image on the sheet P and is stored inside the fixing control circuit 150 or the ROM 120. When the fixing temperature is 150° C., for example, the predetermined temperature range may be a temperature range of 150° C.±10° C.

When the detected temperature falls within the predetermined temperature range (ACT 24: YES), ACT 25 is performed.

When the detected temperature is outside the predetermined temperature range (ACT 24: NO), ACT 26 is performed.

In ACT 25, the fixing control circuit 150 turns on a conveyance permission signal. The conveyance permission signal is used for conveyance control of the image forming apparatus 10 by the CPU 100 as will be described below.

After ACT 25 ends, ACT 22 is performed.

In ACT 26, it is determined whether or not the detected temperature exceeds an upper limit value (a temperature upper limit) of the predetermined temperature range.

When it is determined that the detected temperature exceeds the upper limit value of the predetermined temperature range (ACT 26: YES), ACT 27 is performed.

When it is determined that the detected temperature is equal to or less than the upper limit value of the predetermined temperature range (ACT 26: NO), ACT 28 is performed.

In ACT 27, power supply to the heat generating region, that has started to apply voltage in ACT 22, is turned off. Thereafter, ACT 22 is performed.

In ACT 28, power supply to the heat generating region that has started to apply the voltage in ACT 22 is turned on. Thereafter, ACT 22 is performed.

In this manner, the fixing control circuit 150 performs the ON/OFF control of the power supply for the heat generating region by repeating the operation from ACT 22 until the fixing temperature control end signal is detected in ACT 22. As a result, the temperature of the selected heat generating region is controlled to be within the predetermined temperature range.

In ACT 29, the fixing control circuit 150 turns off all the switches 361e. Therefore, the fixing temperature control ends.

Here, the process returns to the description of ACT 6 shown in FIG. 7.

In ACT 6, the CPU 100 determines whether or not the conveyance permission signal is turned on by the fixing control circuit 150.

When the conveyance permission signal is turned on (ACT 6: YES), the CPU 100 executes an image forming control program which controls the image forming unit 20. Therefore, the image forming control is started. Specifically, first, ACT 7 and ACT 10 are performed in parallel.

When the conveyance permission signal is turned off (ACT 6: NO), ACT 6 is performed.

As described above, in the embodiment, the image forming control is not started until the fixing nip reaches the fixing temperature and the conveyance permission signal is turned on.

When the image forming process is started, the CPU 100 processes the read image data (ACT 7). Thereafter, the CPU 100 sends image data and a control signal of starting image formation to the image forming control circuit 140.

The image forming control circuit 140 performs control of writing an electrostatic latent image on the surface of the photosensitive drum 22 (ACT 8) and developing the electrostatic latent image in the developer 24 (ACT 9). The developed toner image is conveyed to the secondary transfer position by the intermediate transfer belt 21.

Thereafter, the image forming control circuit 140 performs control of ACT 11 to be described below.

On the other hand, in ACT 10, the CPU 100 performs control of conveying the sheet P to a transfer portion. The transfer portion is a position in which the intermediate transfer belt 21 and the secondary transfer roller 33 are in contact with each other. The CPU 100 sends the paper feeding/conveyance control circuit 130 a control signal of starting conveyance of the sheet P toward the transfer portion. The paper feeding/conveyance control circuit 130 drives the resist roller 41.

The leading end of the sheet P reaches the secondary transfer position in accordance with the timing at which the developed toner image moves to the secondary transfer position by the intermediate transfer belt 21.

ACT 11 is started at the timing at which the toner image and the sheet P reach the transfer portion.

In ACT 11, the image forming control circuit 140 performs control of transferring the toner image on the intermediate transfer belt 21 to the sheet P. The image forming control circuit 140 applies the secondary transfer voltage to the secondary transfer roller 33. The application of the secondary transfer voltage is performed until the entire sheet P has passed through the secondary transfer position. The sheet P to which the toner image is transferred is conveyed to the fixing device 36.

Therefore, ACT 11 ends.

When the sheet P is conveyed to the fixing device 36, ACT 12 is performed. In ACT 12, the toner image on the sheet P is fixed by the fixing device 36.

As shown in FIG. 3, the sheet P enters between the fixing belt 363 and the press roller 366 of the fixing device 36. At the fixing nip, the heat generating region corresponding to the paper size of the sheet P is temperature-controlled to be in the predetermined temperature range. The sheet P is heated and pressurized while passing through the fixing nip so that the toner image is fixed on the sheet P.

The fixing temperature control by the fixing control circuit 150 is continued even while the sheet P passes through the fixing device 36. As a result, the fixing belt 363 can maintain the predetermined temperature range at the fixing nip corresponding to the selected heat generating region.

On the other hand, since the fixing belt 363 is not heated in the heat generating region through which the sheet P does not pass, heating of the region to which the toner image need not be fixed is reduced.

When the entire sheet P passes through the fixing nip, passage of the sheet P is detected by a sensor 130b (not shown in the figure). ACT 12 ends.

When the passage of the sheet P in the fixing device 36 is detected by the sensor 130b (not shown in the figure), ACT 13 shown in FIG. 7 is performed. In ACT 13, the CPU 100 determines whether or not to end the printing. The CPU 100 compares the set number of copies with the number of copies already printed and determines to end the printing when printing for the set number of copies is completed.

When the CPU 100 determines that the printing is completed (ACT 13: YES), ACT 14 is performed.

When the CPU 100 determines that the printing is continued (ACT 13: NO), ACT 1 is performed. That is, when image data to be printed still remains, the process is returned to ACT 1 and the same process is repeated until all the printing is completed.

In ACT 14, the CPU 100 performs control to end the fixing temperature control. Specifically, the CPU 100 sends the fixing temperature control end signal to the fixing control circuit 150.

When the fixing control circuit 150 receives the fixing temperature control end signal, ACT 29 branched off from ACT 22 in FIG. 8 is executed. As a result, power supply to all of the heat generating regions is turned off to end the fixing temperature control.

When ACT 14 ends, printing by the image forming apparatus 10 ends.

In the image forming apparatus 10 of the embodiment, the heating member 361 of the fixing device 36 has the plurality of heat generating regions. The plurality of heat generating regions are heated only in a range in which the generating regions overlap the sheet width of the sheet P to be printed. Therefore, power supply to the heat generating resistor 361c of the heat generating region through which the sheet P does not pass is stopped in accordance with the size of the sheet width of the sheet P. Therefore, energy saving is possible when the sheet P with a small sheet width is printed.

In the heating member 361, the electrodes 361b are facing each other in the longitudinal direction of the base member 361a. The electrode pair of the electrodes 361b facing each other in the longitudinal direction of the base member 361a are connected to different polarities of the fixing power source 150a from each other. As a result, the heat generating resistor 361c can be disposed continuously on each of the electrodes 361b. In the heating member 361, no gap is required between adjacent heat generating regions. Since a substantially rectangular heat generating region is continuously formed by the plurality of heat generating regions, unevenness in temperature distribution of the fixing region is reduced.

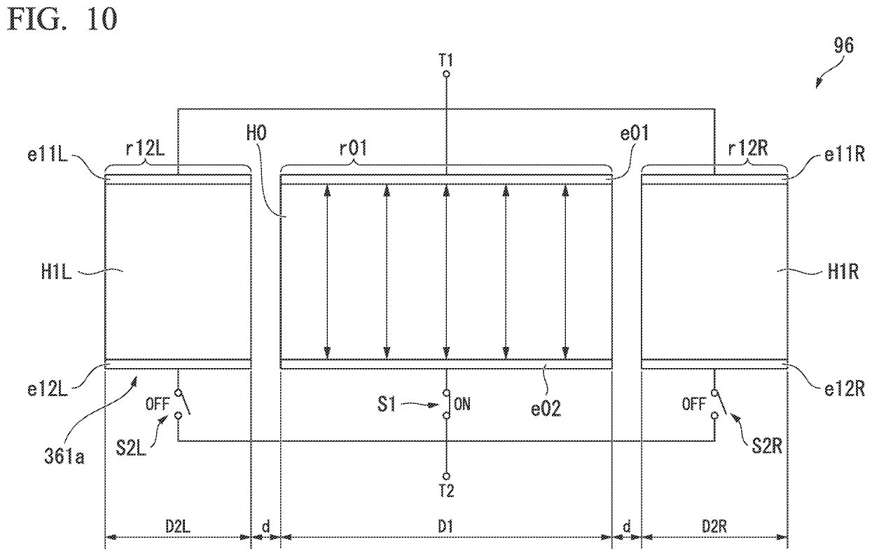

The unevenness of the temperature distribution in the fixing region will be described with reference to a comparative example shown in FIG. 10.

FIG. 10 is a schematic plan view showing an example of a control operation of a heater of the comparative example.

In a heating member 96 serving as a heater of the present comparative example, in order to heat a heat generating region r01 corresponding to the heat generating regions R01L and R01R, electrodes e01 and e02 on the base member 361a are disposed to face in the short direction of the base member 361a. A heat generating resistor HO made of the same material as the heat generating resistor 361c is disposed between the electrodes e01 and e02. The widths of the electrodes e01 and e02 and the heat generating resistor HO in the longitudinal direction of the base member 361a are all D1.

In the heating member 96, in order to heat a heat generating region r12L (r12R) corresponding to the heat generating region R12L (R12R), electrodes e11L and e12L (e11R and e12R) are disposed to face in the short direction of the base member 361a. A heat generating resistor H1L (H1R) made of the same material as the heat generating resistor 361c is disposed between the electrodes e11L and e12L (e11R and e12R). The widths of the electrodes e11L and e12L (e11R and e12R) and the heat generating resistor H1L (H1R) in the longitudinal direction of the base member 361a are all D2L (D2R).

The electrodes e01, e11L, and e11R are electrically connected to a terminal T1.

The electrodes e02, e12L, and e12R are electrically connected to a terminal T2 respectively via switches S1, S2L, and S2R.

In the electrode disposition of the present comparative example, the heat generating region r01 generates heat by turning on the switch Si and turning off the switches S2L and S2R as in the embodiment. At this time, the electrode e02 has the same potential as the terminal T2, whereas the electrodes e12L and e12R have the same potential as the terminal T1. That is, a potential difference between the terminals T1 and T2 is generated between the electrode e12L (e12R) and the electrode e02. Therefore, it is necessary to separate the electrode e12L (e12R) and the electrode e02 from each other by an insulation distance d. When the potential difference between the terminals T1 and T2 is AC 100 V, the insulation distance d is approximately 1.5 mm, for example. When the potential difference between the terminals T1 and T2 is AC 200 V, the insulation distance d is approximately 3.2 mm, for example.

A gap having a width d in which there is no heat generating resistor is necessary between the heat generating region r12L (r12R) and the heat generating region r01.

In the comparative example, when a sheet P having a sheet width larger than D1 is to be passed through, at least the switches S1, S2L, and S2R need to be turned on. In this case, the heat generating regions r12L, r01, and r12R generate heat. However, since the region of the width d between the heat generating region r12L (r12R) and the heat generating region r01, the region of the width d between the heat generating region r12L (r12R) and the heat generating region r01 is a low temperature region.

In such an electrode disposition in the comparative example, fixing unevenness due to the low temperature region between adjacent heat generating regions occurs at the time of fixing the sheet P which requires a plurality of heat generating regions to be heated at the same time.

On the other hand, in the electrode disposition of the heating member 361 in the embodiment, the fixing unevenness due to such unevenness of the temperature distribution can be prevented.

### Second Embodiment

A heater according to a second embodiment and a fixing device using the same will be described.

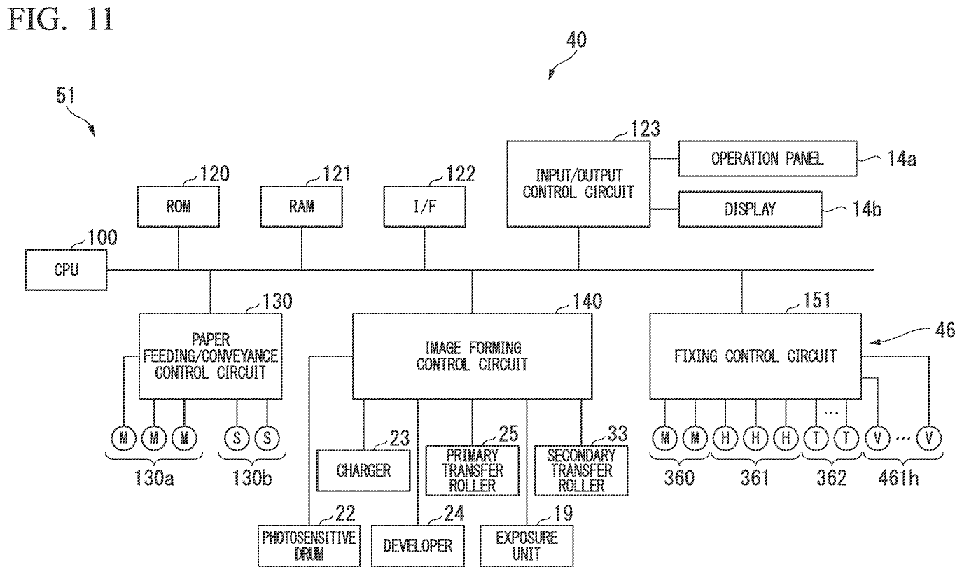

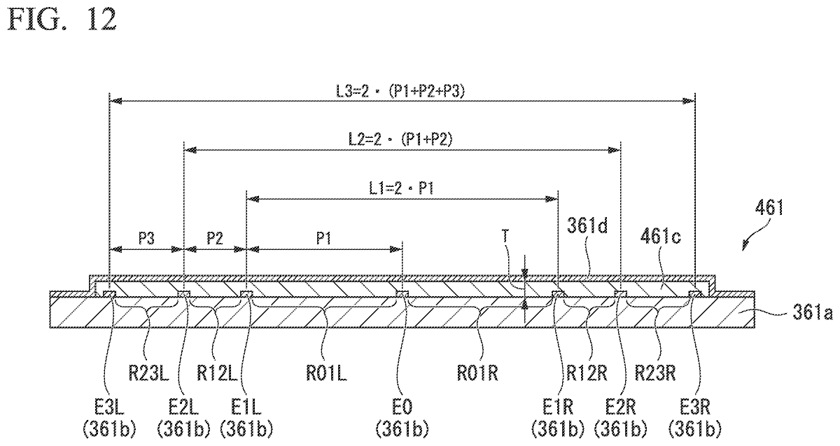

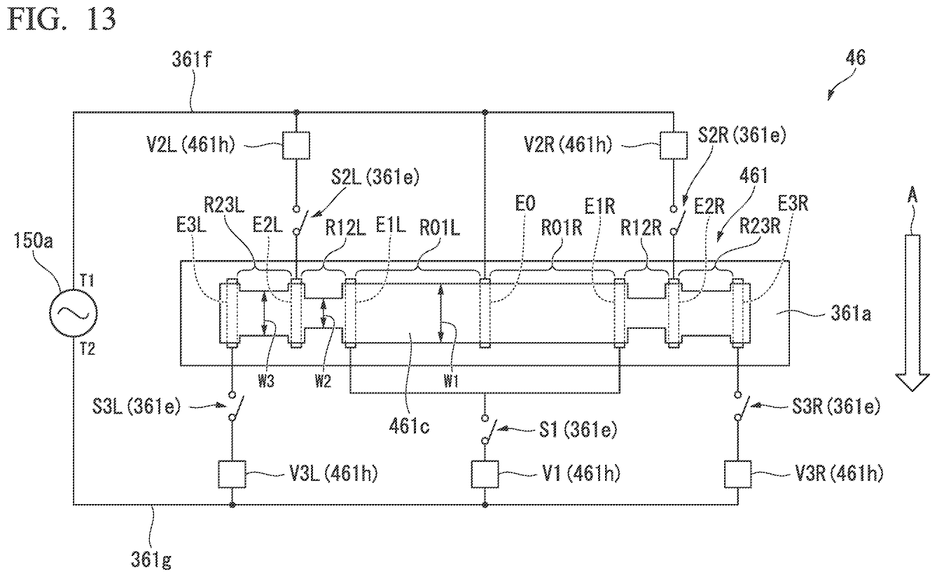

FIG. 11 is a block diagram showing a configuration example of a control system of an image forming apparatus according to the second embodiment. FIG. 12 is a schematic cross-sectional view in a longitudinal direction showing a configuration example of a heating member 461 according to the second embodiment. FIG. 13 is a schematic plan view showing a configuration example of the heating member 461 according to the second embodiment. However, a surface protective layer 361d is omitted in FIG. 13 for easier viewing.

As shown in FIG. 1, an image forming apparatus 40 according to the second embodiment has a fixing device 46 instead of the fixing device 36 of the image forming apparatus 10 of the above-described first embodiment. As shown in FIG. 11, the image forming apparatus 40 has a control system 51 instead of the control system 50 of the image forming apparatus 10 of the above-described first embodiment. The control system 51 has a fixing control circuit 151 (a fixing controller) instead of the fixing control circuit 150 of the control system 50.

As shown in FIG. 3, the fixing device 46 has the heating member 461 (a heater) instead of the heating member 361 of the fixing device 36 according to the above-described first embodiment.

In the fixing device 46, a plurality of temperature detectors 362 (not shown in FIG. 3, see FIG. 11) may be disposed at any position of an inner side and outer side of a fixing belt 363 and a heat generation portion of the heating member 461 in contact with the fixing belt 363. Each of the plurality of temperature detectors 362 is disposed in a position from which a temperature of the range corresponding to one of the heat generating regions of the heating member 461 to be described below is detectable. However, in the embodiment, since a voltage applied to heat generating regions R0L and R0R is controlled by a voltage adjuster V1 which will be described below, the temperature detector 362 is provided only in the range corresponding to either of the heat generating regions R0L and R0R.

A detection output of each temperature detector 362 is sent to the fixing control circuit 151.

Hereinafter, differences from the above-described first embodiment will be mainly described.

As shown in FIG. 12, the heating member 461 has a heat generating resistor 461c instead of the heat generating resistor 361c of the heating member 361 of the above-described first embodiment. However, in the heating member 461, the disposition (disposition position) in which the electrodes E1L, E1R, E2L, E2R, E3L, and E3R are positioned in the longitudinal direction (in a lateral direction as shown in FIG. 12) of the base member 361a is different from that of the disposition according to the above-described first embodiment.

The fixing device 46 is an example of the case in which the disposition of the respective electrodes 361b of the heating member 461 is at an irregular interval.

A disposition interval between the electrode E0 and the electrode E1L (E1R) in the longitudinal direction of the base member 361a is P1. Similarly, a disposition interval between the electrode E1L (E1R) and the electrode E2L (E2R) is P2. Similarly, a disposition interval between the electrode E2L (E2R) and the electrode E3L (E3R) is P3.

In the embodiment, P1=77.7 mm, P2=32.6 mm, P3=45.7 mm are satisfied as an example.

In such a numerical example, a disposition interval L1 of the electrodes E1L and E1R is 155.4 mm, a disposition interval L2 of the electrodes E2L and E2R is 220.6 mm, and a disposition interval L3 of the electrodes E3L and E3R is 312 mm.

In this numerical example, L1, L2, and L3 are 105% the length of sheet widths 148 mm, 210 mm, and 297 mm, respectively.

In this case, when the heat generating regions R01L and R01R are heated, it is possible to fix sheets P of a postcard size, a CD jacket size, and an A5R size. When the heat generating regions R12L, R01L, R01R, and R12R are heated, it is possible to fix the sheets P of a B5R size and an A4R size. When the heat generating regions R23L, R12L, R01L, R01R, R12R, and R23R are heated, it is possible to fix the sheets P of a B5 size, an A4 size, and an A3R size.

In this numerical example, the width of the heat generating region needed for fixing is set to have a margin of 5% with respect to the sheet width of the A5R size, the A4R size, and the A4 size (the A3R size), respectively. When the papers of the A5R size, the A4R size, and the A4 size (the A3R size) are passed through, this numerical example is a setting for heating with a smaller heat generation rate even while including a necessary margin as compared with the case in which paper with a larger size is passed through.

Hereinafter, the electrode disposition will be described using the numerical example described above unless otherwise specified.

As shown in FIG. 13, the heat generating resistor 461c is configured similar to the heat generating resistor 361c according to the above-described first embodiment except that the width in the short direction of the base member 361a is different. Hereinafter, when there is no risk of misunderstanding, the width of the heat generating resistor 461c in the short direction of the base member 361a is referred to simply as a width of the heat generating resistor 461c.

The width of the heat generating resistor 461c is set to have an electric resistance by which a necessary heat generation rate can be obtained in each heat generating region when a voltage is applied.

In the above numerical example, P1>P3>P2. When electric resistivity p of the heat generating resistor 461c is constant, a layer thickness T (refer to FIG. 12) is constant, and a voltage v applied to each of the heat generating regions R01L (R01R), R12L (R12R), and R23L (R23R) is constant, electric resistance r in each heat generating region is proportional to the length L of each heat generating region and is inversely proportional to the width W of the heat generating resistor 461c in each heat generating region.

For example, a heat generation rate q per unit length (hereinafter referred to as a “heat generation rate per unit length”) in the longitudinal direction of the heat generating region is expressed as in the following equation (1).

q=v²/(r·L)=v²·T·W/ρ (1)

For example, it is assumed that the width of the heat generating resistor 461c in the heat generating region R01L (R01R) is W1, the width of the heat generating resistor 461c in the heat generating region R12L (R12R) is W2, and the width of the heat generating resistor 461c in the heat generating region R23L (R23R) is W3.

In this case, when v, T, and p are constant, the heat generation rate per unit length in each of the heat generating regions is proportional to the widths W1, W2, and W3 of the heat generating resistor 461c in each of the heat generating regions. When W1=W2=W3, the heat generation rate per unit length becomes constant.

The heat generation rate per unit length may be set such that the temperature of the fixing nip reaches the required fixing temperature according to heat transfer efficiency from the heating member 461 to the fixing belt 363 in the fixing device 46. In FIG. 13, an example in the case of W1>W3>W2 is shown, but this is merely an example. The sizes of W1, W2, and W3 can be appropriately set.

For example, the case that W1>W2>W3 may be adopted. In this case, the heat generation rate per unit length decreases in the order of the heat generating regions R01L (R01R), R02L (R02R), and R03L (R03R). According to such a setting, since the heating capacity of the heating member 461 is the highest in the heat generating region R01L (R01R), a decrease in temperature distribution at a center portion of the fixing belt 363 after small-sized paper is consecutively passed through is easily reduced, for example.

For example, W1<W2<W3 may be adopted. In this case, the heat generation rate per unit length increases in the order of the heat generating regions R01L (R01R), R02L (R02R), and R03L (R03R). According to such a setting, since the heating capacity of the heating member 461 is the highest in the heat generating region R03L (R03R), a decrease in temperature at both ends of the fixing belt 363 in a conveyance perpendicular direction is easily reduced, for example.

As shown in FIG. 13, the heating member 461 further has a voltage adjuster 461h. As shown in FIG. 11, the voltage adjuster 461h is connected to the fixing control circuit 151 to communicate therewith.

As schematically shown in FIG. 13, the voltage adjuster 461h includes voltage adjusters V1, V2L, V2R, V3L, and V3R.

The voltage adjuster V1 is provided to adjust a voltage applied from a terminal T2 to the electrodes E1L and E1R. The voltage adjuster V2L (V2R) is provided to adjust a voltage applied from a terminal T1 to the electrode E2L (E2R). The voltage adjuster V3L (V3R) is provided to adjust a voltage applied from the terminal T2 to the electrode E3L (E3R).

The voltage adjusters V1, V2L, V2R, V3L, and V3R change the voltages applied to the electrodes E1L, E1R, E2L, E2R, E3L, and E3R according to the control signal from the fixing control circuit 151.

The voltage adjusters V1, V2L, V2R, V3L, and V3R may change the voltages applied to the electrodes E1L, E1R, E2L, E2R, E3L, and E3R continuously or in stages. The value being changed in stages may be an appropriate number of two or more.

The configuration of the voltage adjusters V1, V2L, V2R, V3L, and V3R is not limited as long as the voltage adjusters can change voltages according to the control signal from the fixing control circuit 151. As the voltage adjusters V1, V2L, V2R, V3L, and V3R, a configuration in which electric resistance is changed to cause a voltage drop may be employed, for example. As the voltage adjusters V1, V2L, V2R, V3L, and V3R, an electronic volume, a digital volume, or the like may be used, for example. As the voltage adjusters V1, V2L, V2R, V3L, and V3R, a transformer circuit may be used, for example.

The voltage adjusters V1, V2L, V2R, V3L, and V3R are not limited to a single electronic device. The voltage adjusters V1, V2L, V2R, V3L, and V3R may be configured with an electric circuit including a plurality of electric devices.

The voltage adjusters V1, V2L, V2R, V3L, and V3R are connected to appropriate positions on wirings 361f and 361g depending on the respective configurations. In FIG. 13, a disposition example in which the voltage adjusters have a variable resistor type configuration is schematically shown as an example. For example, the voltage adjuster V1 is connected in series to the wiring path of the wiring 361g between the fixing power source 150a and the electrode E1L (E1R). The voltage adjuster V2L (V2R) is connected in series with the wiring path of the wiring 361f between the fixing power source 150a and the electrode E2L (E2R). The voltage adjuster V3L (V3R) is connected in series with the wiring path of the wiring 361g between the fixing power source 150a and the electrode E3L (E3R). For example, when the voltage adjusters V1, V2L, V2R, V3L, and V3R are configured to include a transformer circuit, the voltage adjusters may be wired to different positions from those in FIG. 13.

The voltage adjusters V1, V2L, V2R, V3L, and V3R change the voltages applied to the electrodes E1L, E1R, E2L, E2R, E3L, and E3R according to the control signal from the fixing control circuit 151.

In addition to the control function of the fixing control circuit 150 according to the above-described first embodiment, the fixing control circuit 151 has a function of controlling the applied voltages to the electrodes E1L (E1R), E2L (E2R), and E3L (E3R) by controlling the voltage adjusters V1, V2L, V2R, V3L, and V3R.

A specific control function of the fixing control circuit 151 will be described in the operation description below.

Next, the following description will be based on an operation of the image forming apparatus 40 at the time of printing.

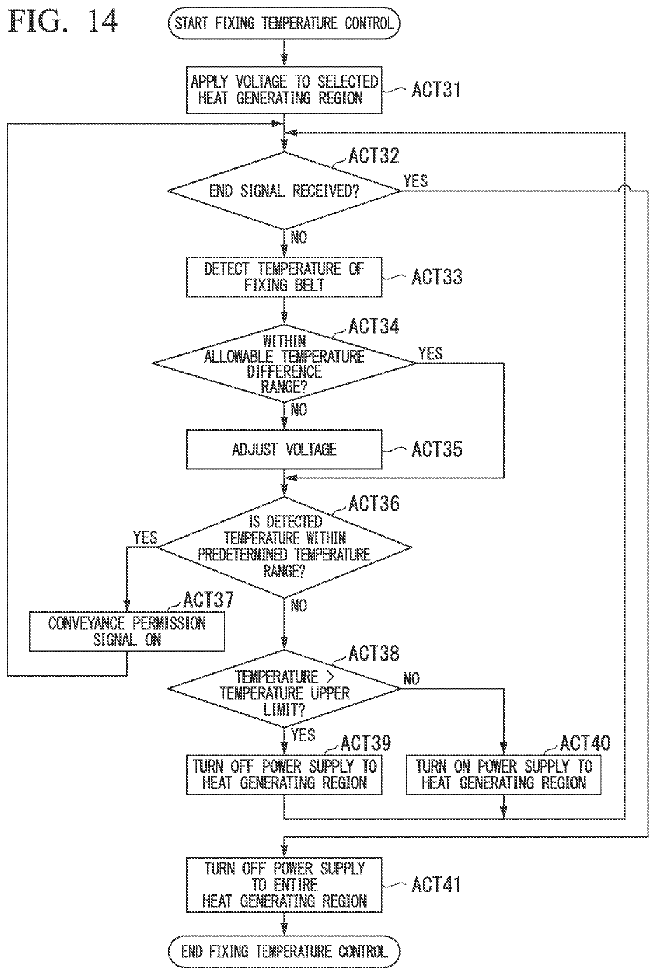

FIG. 14 is a flowchart showing an operation example of a fixing temperature control of the image forming apparatus according to the second embodiment.

The image forming apparatus 40 of the embodiment having the heating member 461 of the embodiment in the fixing device 46 can print on the sheet P according to the flow shown in FIG. 7 as in the image forming apparatus 10 of the above-described first embodiment.

However, in ACT 3 in FIG. 7, the CPU 100 selects the heat generating region to be heated according to the correlation between the sheet width and the heat generating region of the embodiment.

In the above-described numerical example of the disposition interval of the electrodes, the correspondence between the paper size and the heat generating region to be selected is stored in the ROM 120 as follows, for example. For the postcard size, the CD jacket size, and the A5R size, the heat generating regions R01L and R01R are selected. For the B5R size and the A4R size, the heat generating regions R12L, R01L, R01R, and R12R are selected. For the B5 size, the A4 size, and the A3R size, the heat generating regions R23L, R12L, R01L, R01R, R12R, and R23R are selected.

In addition, in the image forming apparatus 40 of the embodiment, the fixing temperature control is performed in accordance with the flow shown in FIG. 14. Hereinafter, the fixing temperature control of the embodiment will be described focusing on differences from the above-described first embodiment.

The fixing control circuit 151 executes ACT 31 to ACT 41 shown in FIG. 14 in accordance with the flow shown in FIG. 14.

First, ACT 31 is performed. ACT 31 performs the same operation as in ACT 21 of the above-described first embodiment. In the embodiment, a default value determined in advance is used as the voltage setting value of the voltage adjuster 461h in ACT 31. The variation width of voltage from the default value is set so that at least the voltage to be applied to the electrode pair can increase.

After ACT 31, ACT 32 is performed. In ACT 32, the same operation as in ACT 32 of the above-described first embodiment is performed by the fixing control circuit 151.

However, when the fixing control circuit 151 receives a fixing temperature control end signal (ACT 32: YES), ACT 41 is performed.

When the fixing control circuit 151 has not received the fixing temperature control end signal (ACT 32: NO), ACT 33 is performed.

In ACT 33, the fixing control circuit 151 acquires temperature information of the fixing belt 363 forming the fixing nip, for each heat generating region, from each temperature detector 362.

When the temperature detector 362 indirectly detects the temperature of the fixing belt 363, the fixing control circuit 151 converts the detected temperature into the temperature of the fixing nip of the fixing belt 363. The correlation between the temperature detected by the temperature detector 362 and the temperature of the fixing nip is stored in the ROM 120 in advance as a conversion table or the like, for example.

However, the fixing control circuit 151 executes the following operation according to the temperature information by the temperature detector 362 which detects the temperature of the selected heat generating region.

Therefore, ACT 33 ends.

After ACT 33, ACT 34 is performed. In ACT 34, the fixing control circuit 151 determines whether or not the temperature of each heat generating region detected in ACT 33 (hereinafter referred to as a detected temperature) falls within an allowable temperature difference range.

For example, the fixing control circuit 151 calculates a temperature difference between the highest temperature in the detected temperatures and each detected temperature. The fixing control circuit 151 compares the calculated temperature difference with the allowable temperature difference range stored in advance in the ROM 120 and determines the temperature difference for each heat generating region.

When all of the temperature differences fall within the allowable temperature difference range (ACT 34: YES), ACT 36 is performed.

When any one of the respective temperature differences does not fall within the allowable temperature difference range (ACT 34: NO), ACT 35 is performed.

In ACT 35, a voltage adjustment is performed by the fixing control circuit 151. The fixing control circuit 151 changes the voltage to be applied to the electrode pair corresponding to the heat generating region in which the temperature detected is outside the allowable temperature difference range. Specifically, the fixing control circuit 151 sends the voltage adjuster 461h a control signal for changing the voltage setting value according to the correspondence table of the temperature difference and the voltage change value stored in advance in the ROM 120.

When the temperature difference does not fall within the allowable temperature difference range due to the excessively low temperature of the heat generating regions R01L and R01R, for example, the applied voltage between the electrodes E0 and E1L (E1R) is further increased by the control of the fixing control circuit 151.

At this time, when there is no need to change the voltage to be applied to the other electrode pair, the voltages by the voltage adjusters V2L, V2R, V3L, and V3R are changed as needed to maintain the voltage to be applied to the other electrode pair. When it is necessary to change the voltage to be applied to the other electrode pair, the applied voltage of the other electrode pair is also changed.

Therefore, ACT 35 ends. After ACT 35, ACT 36 is performed.

In this manner, when power supply is started after the voltage to be applied to the electrode pair is changed in ACT 35, the heat generation rate of the heat generating region between the electrode pair in which the applied voltage is changed is changed. For example, when the voltages applied to the heat generating regions R01L and R01R increase, the heat generation rate in the heat generating regions R01L and R01R increases.

In ACT 34, the fixing control circuit 151 determines whether or not the detected temperature detected in ACT 33 is within the predetermined temperature range. The fixing control circuit 151 determines it according to the lowest detected temperature (referred to as a lower limit detected temperature) in a range corresponding to the selected heat generating region.

The predetermined temperature range is the same as the temperature range in ACT 24 according to the above-described first embodiment.

When the lower limit detected temperature falls within the predetermined temperature range (ACT 36: YES), ACT 37 is performed.

When the lower limit detected temperature is outside the predetermined temperature range (ACT 36: NO), ACT 38 is performed.

The same operations as in ACTs 26, 27, 28, and 29 of the above-described first embodiment are performed in ACTs 38, 39, 40, and 41 respectively by the fixing control circuit 151. However, when ACT 39 and ACT 40 end, ACT 32 is performed.

As in the image forming apparatus 10 of the above-described first embodiment, the image forming apparatus 40 of the embodiment having the heating member 461 of the embodiment can save energy and reduce unevenness of the temperature distribution of the fixing region.

In the embodiment, the disposition interval of the electrodes is not limited to a regular interval. When paper with a specific size such as a size with a high frequency of use is passed, for example, it is possible to set heating with an even lower heat generation rate even while including a necessary margin as compared with a case in which paper with an even larger size is passed through. As a result, the average amount of power usage of the image forming apparatus 40 is more easily reduced.

In addition, in the image forming apparatus 40 of the present invention, electric resistance of each heat generating region is appropriately set by changing the width of the heat generating resistor 461c. Therefore, the heat generation rate per unit length can be changed for each heat generating region.

In the heat generating region in which a temperature decline may easily occur due to passage of thick paper such as a postcard, for example, by increasing the heat generation rate per unit length in advance, the temperature decline of the fixing belt 363 is less likely to occur even when a many sheets of paper are consecutively passed therethrough. As a result, it is possible to reduce an influence on the image quality such as uneven gloss due to the temperature decline.

In the heat generating region in which the temperature decline of the fixing belt 363 may easily occur due to an influence such as a temperature distribution inside the image forming apparatus 40, for example, by increasing the heat generation rate per unit length in advance, the temperature decline of the fixing belt 363 is less likely to occur even when many sheets of paper are consecutively passed therethrough. As a result, it is possible to reduce an influence on the image quality such as uneven gloss due to the temperature decline.

Furthermore, since the voltage adjuster 461h is provided in the image forming apparatus 40 of the embodiment, the voltage applied to each electrode in the heating member 461 can be changed.

The voltage applied to each electrode can be changed for each heat generating region by setting a default value in advance. Therefore, the heat generation rate per unit length in each heat generating region can be changed also by a level of the applied voltage.

When the heat generation rate per unit length is different according to the electric resistance in each heat generating region, for example, the heat generation rate per unit length in each heat generating region can be equalized using the default value.

It is also possible to set the default value such that the difference of the heat generation rate per unit length is further increased according to the electric resistance in each heat generating region.

As described above, in the image forming apparatus 40 of the embodiment, flexibility in setting the heat generation rate per unit length in each heat generating region is increased using a combination of the electric resistance and the applied voltage in each heat generating region.

Furthermore, in the image forming apparatus 40 of the embodiment, when the temperature difference between the heat generating region increases during the fixing operation, the voltage to be applied to the electrode pair corresponding to the heat generating region in which the temperature difference has increased is automatically changed to reduce the temperature difference by the fixing control circuit 151.

Therefore, even when printing is performed for mixed sheets P with various sizes and thicknesses, the temperature distribution in the conveyance perpendicular direction of the heat generating region used for fixing is stabilized. As a result, occurrence of fixing unevenness, gloss unevenness, or the like due to a temperature variation in each heat generating range is reduced.

### Third Embodiment

A heater according to a third embodiment and a fixing device using the same will be described.

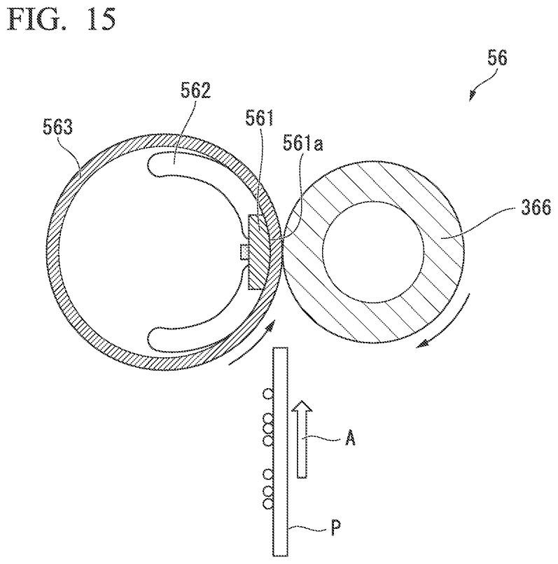

FIG. 15 is a schematic cross-sectional view showing a configuration example of a main part of the heater according to the third embodiment.

As shown in FIG. 15, a fixing device 56 has a heating film 563 and a heating member 561 serving as the heater of the embodiment instead of the fixing belt 363 and the heating member 361 of the fixing device 36 according to the above-described first embodiment. In the fixing device 56, the belt conveying rollers 364 and the tension roller 365 of the fixing device 36 according to the above-described first embodiment are removed.

The fixing device 56 further has a heater holder 562.

Hereinafter, differences from the above-described first embodiment will be mainly described.

The heating film 563 is a tubular member that rotates in conjunction with rotation of the press roller 366. The heating film 563 is slidable with the heating member 561 to be described below on an inner circumferential surface. The heating film 563 is configured of a resin film having heat resistance against heat generated by the heating member 561, for example.

An elastic layer may be formed on an outer circumferential surface of the heating film 563 so that a fixing nip with an appropriate width is formed between the elastic layer and the press roller 366.

The heating member 561 is configured similar to the heating member 361 of the above-described first embodiment except that it has a projected surface 561a which comes into contact with the inner circumferential surface of the heating film 563. The projected surface 561a enables smooth sliding of the heating film 563 by reducing sliding resistance with the heating film 563. That is, a friction coefficient between the inner circumferential surface of the heating film 563 and the projected surface 561a is smaller than a friction coefficient between the outer circumferential surface of the heating film 563 and a surface of the press roller 366.

Furthermore, the friction coefficient between the inner circumferential surface of the heating film 563 and the projected surface 561a is smaller than a friction coefficient with respect to the surface of the sheet P, on which the toner image is formed, entering between the heating film 563 and the press roller 366.

The heating member 561 is held by the heater holder 562. The heater holder 562 presses the projected surface 561a of the heating member 561 against the inner circumferential surface of the heating film 563. The heating film 563 against which the projected surface 561a is pressed is in contact with the opposing press roller 366 and forms the fixing nip between the press roller 366 and the heating film 563.

In addition, at the position near the heating member 561, the heater holder 562 guides the inner circumferential surface of the heating film 563 in contact with the heating member 561 in substantially arc shape.

The heater holder 562 is configured of a resin material which has heat resistance against heat generated by the heating member 561 and is slidable with the inner circumferential surface of the heating film 563, for example. A friction coefficient between the inner circumferential surface of the heating film 563 and the heater holder 562 is smaller than the friction coefficient between the outer circumferential surface of the heating film 563 and the surface of the press roller 366.

In the fixing device 56 having such a configuration, as the press roller 366 rotates clockwise as in the drawing, the heating film 563 rotates counterclockwise as in the drawing. On the inner circumferential surface of the heating film 563, heat from the heating member 561 is thermally conducted via the projected surface 561a. When the sheet P enters the fixing nip, the heating film 563 is driven to rotate by the press roller 366 with the sheet P interposed therebetween and continues to rotate counterclockwise as in the drawing.

The fixing device 56 differs from the fixing device 36 in terms of the driving method of the heating film 563 instead of the fixing belt 363 and in terms of the projected surface 561a being formed on the surface of the heating member 561. However, the fixing device 56 is the same as the fixing device 36 of the above-described first embodiment in that the fixing can be performed by switching the heat generating region according to the paper size of the sheet P.

The fixing device 56 can be used instead of the fixing device 36 of the image forming apparatus 10 of the above-described first embodiment.

The image forming apparatus 10 having the heating member 561 of the embodiment instead of the fixing device 36 can save energy and reduce unevenness of the temperature distribution of the fixing region as described in the above-described first embodiment.

### Fourth Embodiment

A heater according to a fourth embodiment and a fixing device using the same will be described.

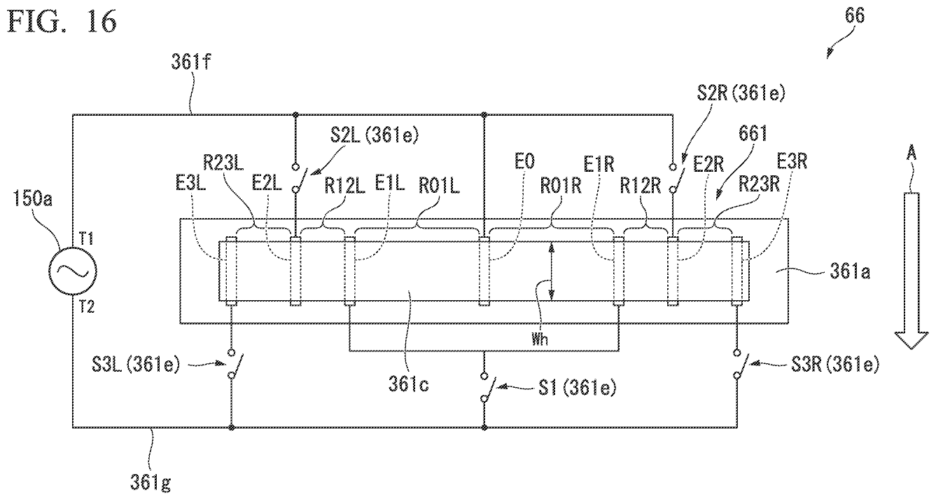

FIG. 16 is a schematic plan view showing a configuration example of the heater according to the fourth embodiment. However, a surface protective layer 361d is omitted in FIG. 16 for easier viewing.

As shown in FIG. 1, an image forming apparatus 60 according to the fourth embodiment has a fixing device 66 instead of the fixing device 36 of the image forming apparatus 10 of the above-described first embodiment. As shown in FIG. 6, the image forming apparatus 60 has a control system 52 instead of the control system 50 of the image forming apparatus 10 of the above-described first embodiment. The control system 52 has a fixing control circuit 152 (a fixing controller) instead of the fixing control circuit 150 of the control system 50.

As shown in FIG. 3, the fixing device 66 has a heating member 661 (a heater) instead of the heating member 361 of the fixing device 36 according to the above-described first embodiment.

Hereinafter, differences from the above-described first embodiment will be mainly described.

The heating member 661 is configured by changing the disposition of the electrodes E3L, E2L, E1L, E0 E1R, E2R, and E3R in the heating member 361 of the above-described first embodiment. The disposition of electrodes E3L, E2L, E1L, E0 E1R, E2R, and E3R in the embodiment is similar to the disposition of the respective electrodes in the heating member 461 according to the second embodiment. Heat generating regions R23L, R12L, R01L, R01R, R12R, and R23R same as those according to the second embodiment are formed between each electrode pair. The width of a heat generating resistor 361c in each heat generating region of the embodiment is constant as described in the above-described first embodiment.

The fixing control circuit 152 has the same configuration as the fixing control circuit 150 of the above-described first embodiment except that selection of heat generation of the heat generating region is performed as in the fixing control circuit 151 according to the second embodiment according to the disposition of each heat generating region.

The image forming apparatus 60 of the embodiment prints an image on a sheet P as described in the above-described first embodiment except that the operation of ACT 3 (refer to FIG. 7) according to the above-described first embodiment is performed as described in the second embodiment.

In the embodiment, since the width of the heat generating resistor 361c has a constant value Wh in each heat generating region, a heat generation rate per unit length is constant in each heat generating region.

The image forming apparatus 60 of the embodiment having the heating member 661 of the embodiment can save energy and reduce unevenness in temperature distribution of the fixing region as in the image forming apparatus 10 of the above-described first embodiment.

In the embodiment, a disposition interval of the electrode is not limited to a regular interval. When paper of a specific size such as a size with a high frequency of use is passed through, for example, it is possible to set heating with an even lower heat generation rate even while including a necessary margin as compared with a case in which paper with an even larger size is passed through. As a result, the average amount of power usage of the image forming apparatus 60 is easily reduced.

Furthermore, according to the heating member 661 of the embodiment, heat generation is performed such that the heat generation rate per unit length is equal by applying a constant voltage to each electrode pair as described in the above-described first embodiment. Therefore, the temperature distribution among a plurality of selected heat generating regions is easily uniform.

### Fifth Embodiment

A heater according to a fifth embodiment and a fixing device using the same will be described.

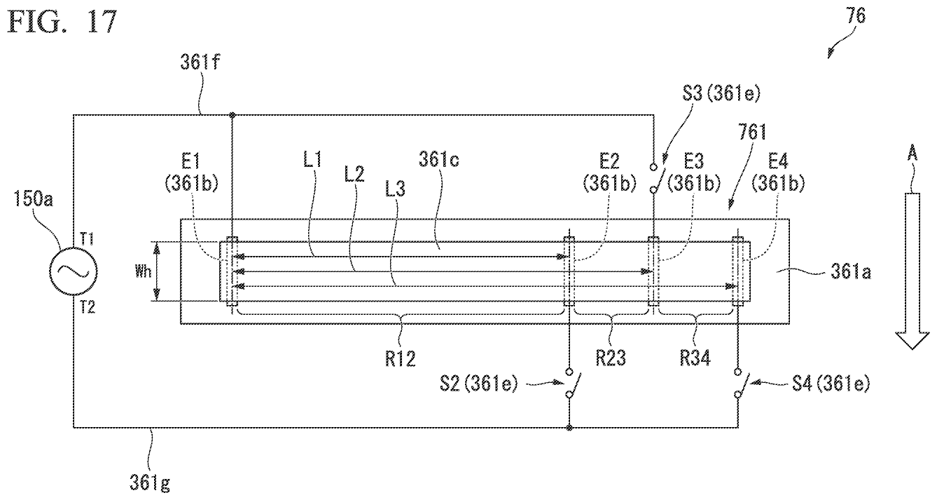

FIG. 17 is a schematic plan view showing a configuration example of the heater according to the fifth embodiment. However, a surface protective layer 361d is omitted for ease of viewing in FIG. 17.

As shown in FIG. 1, an image forming apparatus 70 according to the fifth embodiment has a fixing device 76 and a paper feeding cassette 78 instead of the fixing device 36 and the paper feeding cassette 18 of the image forming apparatus 10 of the above-described first embodiment. As shown in FIG. 6, the image forming apparatus 70 has a control system 53 instead of the control system 50 of the image forming apparatus 10 of the above-described first embodiment. The control system 53 has a fixing control circuit 153 (a fixing controller) instead of the fixing control circuit 150 of the control system 50.

As shown in FIG. 3, the fixing device 76 has a heating member 761 (a heater) instead of the heating member 361 of the fixing device 36 according to the above-described first embodiment.

The paper feeding cassette 78 accommodates the sheet P of any of various sizes on one side reference. For example, in the sheet P of any of various sizes, the sheet end on the left side with respect to the conveying direction is aligned at a normal position.

The image forming apparatus 70 is different in that the sheet P is conveyed on one side reference, whereas the image forming apparatus 10 of the above-described first embodiment conveys the sheet P on the central reference.

Hereinafter, differences from the above-described first embodiment will be mainly described.

As shown in FIG. 17, the heating member 761 has an electrode 361b as in the heating member 361 of the above-described first embodiment. However, while the electrode 361b of the configuration example of the heating member 361 includes the electrodes E3L, E2L, E1L, E0, E1R, E2R, and E3R, the electrode 361b of the heating member 761 includes an electrode E1 (a first end electrode), electrodes E2 and E3, and an electrode E4 (a second end electrode). However, the number of the electrodes 361b in the embodiment is an example. The number of the electrodes 361b in the embodiment is not limited as long as it is three or more.

The electrodes E1 and E4 are configured and disposed similar to the electrodes E3L and E3R in the heating member 461 of the above-described first embodiment. For example, a disposition interval of the electrodes E1 and E4 in the longitudinal direction of the heating member 661 is L3 (=2·(P1+P2+P3)) similar to the disposition interval of the electrodes E3L and E3R according to the second embodiment.

The electrode E2 is disposed between the electrodes E1 and E4 at a position whose disposition interval with respect to the electrode E1 is L2. Here, L2 is L1 (=2·P1) as in the disposition interval of the electrodes E2L and E2R according to the second embodiment.

The electrode E3 is disposed between the electrodes E1 and E4 at a position whose disposition interval with respect to the electrode E1 is L1. Here, L1 is L2 (=2·(P1+P2)) as in the disposition interval of the electrodes E1L and E1R according to the second embodiment.

With such a configuration, a heat generating region R12 having the length L1 is formed between the electrodes E1 and E2. A heat generating region R23 having a length L2-L1 is formed between the electrodes E2 and E3. A heat generating region R34 having a length L3-L2 is formed between the electrodes E3 and E4. The width of the heat generating resistor 361c in each heat generating region of the embodiment is a constant value Wh as described in the above-described first embodiment.

The heating member 761 has a switch 361e as in the heating member 361 of the above-described first embodiment. However, while the switch 361e of the configuration example of the heating member 361 includes switches S2L, S2R, S1, S3L, and S3R, the switch 361e of the heating member 761 includes switches S2, S3, and S4. However, the number of switches 361e in the embodiment is an example. The number of the switches 361e in the embodiment can be appropriately provided according to the number of the electrodes 361b.

The electrode E1 is always electrically connected to a terminal T1 by a wiring 361f.

The electrode E2 is connected to a terminal T2 via the switch S2. The switch S2 can turn on or off the electric connection between the electrode E2 and the terminal T2.

The electrode E3 is connected to the terminal T1 via the switch S3. The switch S3 can turn on or off the electric connection between the electrode E3 and the terminal T1.

The electrode E4 is connected to the terminal T2 via the switch S4. The switch S4 can turn on or off the electric connection between the electrode E4 and the terminal T2.

A switching operation of each switch 361e is individually controlled by the fixing control circuit 153 to be described below.

The fixing control circuit 153 has the same configuration as the fixing control circuit 150 of the above-described first embodiment except that selected control of heat generation of the heat generating region is different according to the disposition of each heat generating region.

The image forming apparatus 70 of the embodiment prints an image on the sheet P as described in the above-described first embodiment except that the operation of ACT 3 (refer to FIG. 7) according to the above-described first embodiment is different.

Specifically, in a ROM 120 in the embodiment, a correspondence between a paper size and the heat generating region to be selected is stored as follows. In the case of a postcard size, the heat generating region R12 is selected. In the case of a CD jacket size, an A5R size, a B5R size, and an A4R size, the heat generating regions R12 and R23 are selected. In the case of a B5 size, an A4 size, and an A3R size, the heat generating regions R12, R23, and R34 are selected.

In ACT 3 in the embodiment, the CPU 100 selects the heat generating region corresponding to the paper size according to the above information stored in the ROM 120.

As in the image forming apparatus 10 of the above-described first embodiment, the image forming apparatus 70 of the embodiment having the heating member 761 of the embodiment can save energy and reduce unevenness in temperature distribution of the fixing region.

In the embodiment, when the sheet P is conveyed on one side reference, for example, when paper with a specific size such as a size with a high frequency of use is passed through, it is possible to set heating with a minimum heat generation rate including a necessary margin. As a result, the average amount of power usage of the image forming apparatus 70 is more easily reduced

Furthermore, according to the heating member 761 of the embodiment, when the sheet P of the same size as described in the above-described first embodiment is fixed, it is possible to reduce the number of the electrodes 361b and the switches 361e.

### Sixth Embodiment

A heater according to a sixth embodiment and a fixing device using the same will be described.

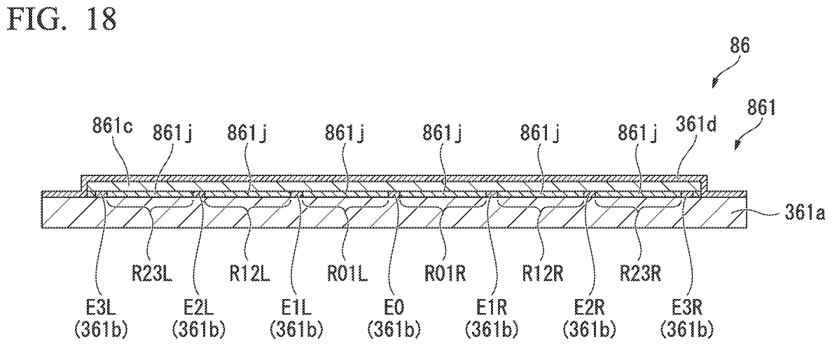

FIG. 18 is a schematic cross-sectional view showing a configuration example of the heater according to the sixth embodiment.

As shown in FIG. 1, an image forming apparatus 80 according to the sixth embodiment has a fixing device 86 instead of the fixing device 36 of the image forming apparatus 10 of the above-described first embodiment.

As shown in FIG. 3, the fixing device 86 has a heating member 861 (a heater) instead of the heating member 361 of the fixing device 36 according to the above-described first embodiment.

Hereinafter, differences from the above-described first embodiment will be mainly described.

As shown in FIG. 18, the heating member 861 has a heat generating resistor 861c instead of the heat generating resistor 361c in the heating member 361 of the above-described first embodiment and is configured to further include an insulating layer 861j.

The insulating layer 861j is disposed in a region other than the electrode 361b on a surface of a base member 361a on which the electrode 361b is disposed. The insulating layer 861j is disposed at least in a portion sandwiched between the electrodes 361b in a longitudinal direction of the base member 361a and in a range overlapping the heat generating region.

The layer thickness of the insulating layer 861j is not limited. The insulating layer 861j can be used to change the thickness of a heat generating resistor 861c to be described below in the longitudinal direction. In this case, the layer thickness of the insulating layer 861j is appropriately set so that a necessary thickness can be formed for the heat generating resistor 861c.

In the configuration example shown in FIG. 18, the insulating layer 861j is disposed to fill the space between the respective electrodes. The layer thickness of the insulating layer 861j in the configuration example shown in FIG. 18 is the same as the thickness of the electrode 361b. Therefore, a layered portion with a constant layer thickness including the electrode 361b and the insulating layer 861j is formed on the surface of the base member 361a.

The material of the insulating layer 861j is not particularly limited as long as it has a withstand voltage against the voltage applied to each electrode. As a material of the insulating layer 861j, a metal oxide, a resin, a ceramic material, or the like may be used, for example.

A method of manufacturing the insulating layer 861j is not particularly limited. As a method of manufacturing the insulating layer 861j, an appropriate method of forming a film may be used depending on the material, for example.

The heat generating resistor 861c is formed of the same material as the heat generating resistor 361c according to the above-described first embodiment and is formed in the same shape as the heat generating resistor 361c in a plan view. The heat generating resistor 861c is formed in a layer shape covering each electrode 361b and the insulating layer 861j. In the configuration example shown in FIG. 18, the layer thickness of the heat generating resistor 861c is constant.

Such a heat generating resistor 861c is easily manufactured using, for example, an appropriate method of forming a film after forming the electrode 361b and the insulating layer 861j on the base member 361a.

As in the configuration example shown in FIG. 18, when the thickness of the electrode 361b is equal to the layer thickness of the insulating layer 861j, since the heat generating resistor 861c is formed on a smooth flat surface, the heat generating resistor 861c with uniform thickness can be easily manufactured.

In this case, since unevenness of a heat generation rate due to a variation in thickness of the heat generating resistor 861c is eliminated, unevenness in temperature distribution of the heat generating region is reduced.

Furthermore, in this case, since surface irregularities of the heat generating resistor 861c are reduced, the surface after a surface protective layer 361d is further laminated is also formed to be smooth. Since the flatness of a surface of the surface protective layer 361d is improved, a pressing force of the heating member 861 against a fixing belt 363 becomes uniform. As a result, since unevenness in thermal conduction due to non-uniformity in a pressed state is reduced, uniformity of the temperature distribution in the heat generating region is improved.

It is conceivable to increase the thickness of the electrode 361b to reduce electric resistance of the electrode 361b.

In this case, when there is no insulating layer 861j, there is a concern that variation in thickness of the heat generating resistor 861c near the electrode 361b increases. When such a variation in thickness is excessively large, a non-uniform temperature distribution may be formed.

Alternatively, when there is no insulating layer 861j, the surface of the heat generating resistor 861c near the electrode 361b may rise. As a result, flatness of the surface of the heat generating resistor 861c may be degraded.

However, in the embodiment, even when the electrode 361b is formed to be thick, since the thickness of the insulating layer 861j can be changed according to a thickness thereof, the variation in thickness of the heat generating resistor 861c can be reduced and the flatness of the surface of the heat generating resistor 861c can be secured.

However, unlike the configuration example of FIG. 18, the heat generating resistor 861c may be laminated in a state in which the layer thickness of the insulating layer 861j is different from the thickness of the electrode 361b. In this case, the thickness of the heat generating resistor 861c can be changed according to the change in thickness of the insulating layer 861j.

In this case, even when the width of the heat generating resistor 861c is constant, the electric resistance in the heat generating region is changed due to the variation in thickness of the heat generating resistor 861c.

As in the image forming apparatus 10 of the above-described first embodiment, the image forming apparatus 80 of the embodiment having the heating member 861 of the embodiment can save energy and reduce unevenness in temperature distribution of the fixing region.

According to at least one of the above-described embodiments, it is possible to provide a heater that can save energy and reduce unevenness in temperature distribution of the fixing region by including three or more electrodes disposed on the base member to be spaced apart from each other in a longitudinal direction of the base member, a heat generating resistor which electrically interconnects electrodes which form an electrode pair and face each other in the longitudinal direction among the electrodes, a wiring which connects the electrodes forming the electrode pair to have different polarities from each other, and a switch connected to the wiring and configured to select an electrode to which a voltage is to be applied.

In addition, in each of the above-described embodiments, the switch 361e may be integrally formed with the heating member (the heater) 361, 461, 561, 661, 761, or 861, or may be separately formed therefrom. Similarly, the fixing control circuit (the fixing controller) 150, 151, 152 or 153 may also be integrally formed with the heating member 361, 461, 561, 661, 761, or 861, or may be separately formed therefrom. Similarly, the voltage adjuster 461h may also be integrally formed with the heating member 461 or may be separately formed therefrom.

In the above-described second embodiment, an example in which the voltage to be applied to the electrode pair can be changed by the voltage adjuster 461h has been described. However, a configuration in which the voltage adjuster 461h is removed may be used when printing with a high degree of quality can be performed without changing the applied voltage.

In the above-described first embodiment and third to sixth embodiments, examples in which the fixing device does not have the voltage adjuster 461h have been described. However, also in the above-described first embodiment and third to sixth embodiments, configurations in which the applied voltage can be changed may be used by having the voltage adjuster 461h and the fixing control circuit 151 as described in the second embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A heater, comprising:
a base member having a first dimension in a longitudinal direction;
a first electrode, a second electrode, and a third electrode on the base member spaced apart from each other in the longitudinal direction, wherein the first and the second electrodes are adjacent to each other in the longitudinal direction and the second and third electrodes are adjacent to each other in the longitudinal direction;
a heat generating resistor on the base member and electrically interconnecting the first, second, and third electrodes;
a wiring which connects the first, second, and third electrodes such that adjacent electrodes have different polarities from each other;
a switch connected to the wiring and configured to selectively apply a voltage to the first, second, and third electrodes; and
a surface protective layer on the base member, the surface protective layer being different from the base member and covering a surface of the heat generating resistor, wherein
the first, second, and third electrodes are between the heat generating resistor and the base member.

2. The heater according to claim 1, wherein
the heat generating resistor is between the surface protective layer and the base member.

3. The heater according to claim 1, further comprising:
a voltage adjuster connected to the wiring and configured to change the voltage applied to the first, second, and third electrodes by the switch according to a control signal.

4. The heater according to claim 1, wherein
a distance between the first electrode and the second electrode is different from a distance between the second electrode and the third electrode.

5. The heater according to claim 1, wherein
the heat generating resistor has a width between the first and second electrodes that is different from a width of the heat generating resistor between the second and third electrodes, the widths being dimensions in a direction perpendicular to the longitudinal direction.

6. The heater according to claim 1, further comprising:
a fourth electrode on the base member and electrically connected to the heat generating resistor; and
a fifth electrode on the base member and electrically connected to the heat generating resistor, wherein
the first through fifth electrodes are disposed along the longitudinal direction such that positions of the first through fifth electrodes are symmetrical in the longitudinal direction with respect to the third electrode and the second and fourth electrodes are symmetrical in the longitudinal direction with respect to the third electrode.

7. The heater according to claim 1, wherein
the heat generating resistor covers the first, second, and third electrodes on the base member and extends in the longitudinal direction.

8. The heater according to claim 1, wherein
the heat generating resistor has a thickness between the first and second electrodes that is different from a thickness of the heat generating resistor between the second and third electrodes, the thicknesses being dimensions in a direction perpendicular to a surface of the base member.

9. The heater according to claim 1, wherein
the first electrode is at a first end in the longitudinal direction of the base member and a distance between the first and second electrodes in the longitudinal direction is greater than a distance between the second and third electrodes in the longitudinal direction.

10. An image forming apparatus, comprising:
a base member having a first dimension in a longitudinal direction;
a first electrode, a second electrode, and a third electrode on the base member spaced apart from each other in the longitudinal direction, wherein the first and the second electrodes are adjacent to each other in the longitudinal direction and the second and third electrodes are adjacent to each other in the longitudinal direction;
a heat generating resistor on the base member and electrically interconnecting the first, second, and third electrodes;
a wiring which connects the first, second, and third electrodes such that adjacent electrodes have different polarities from each other;
a switch connected to the wiring and configured to selectively apply a voltage to the first, second, and third electrodes;
a fixing controller configured to control the switch; and
a surface protective layer on the base member, the surface protective layer being different from the surface protective layer and covering a surface of the heat generating resistor, wherein
the first, second, and third electrodes are between the heat generating resistor and the base member.

11. The image forming apparatus according to claim 10, wherein
the heat generating resistor is between the surface protective layer and the base member.

12. The image forming apparatus according to claim 10, wherein
a distance between the first electrode and the second electrode is different from a distance between the second electrode and the third electrode.

13. The image forming apparatus according to claim 10, wherein
the heat generating resistor has a width between the first and second electrodes that is different from a width of the heat generating resistor between the second and third electrodes, the widths being dimensions in a direction perpendicular to the longitudinal direction.

14. The image forming apparatus according to claim 10, wherein
the heat generating resistor has a thickness between the first and second electrodes that is different from a thickness of the heat generating resistor between the second and third electrodes, the thicknesses being dimensions in a direction perpendicular to a surface of the base member.

15. The image forming apparatus according to claim 10, wherein
the first electrode is at a first end in the longitudinal direction of the base member and a distance between the first and second electrodes in the longitudinal direction is greater than a distance between the second and third electrodes in the longitudinal direction.

16. An image forming apparatus, comprising:
a base member having a first dimension in a longitudinal direction;
a first electrode, a second electrode, and a third electrode on the base member spaced apart from each other in the longitudinal direction, wherein the first and the second electrodes are adjacent to each other in the longitudinal direction and the second and third electrodes are adjacent to each other in the longitudinal direction;
a heat generating resistor on the base member and electrically interconnecting the first, second, and third electrodes;
a wiring which connects the first, second, and third electrodes such that adjacent electrodes have different polarities from each other;
a switch connected to the wiring and configured to selectively apply a voltage to the first, second, and third electrodes;
a voltage adjuster connected to the wiring and configured to change the voltage applied to the first, second, and third electrodes according to a control signal;
a surface protective layer on the base member, the surface protective layer being different from the surface protective layer and covering a surface of the heat generating resistor;
a fixing belt contacting the surface protective layer and configured to be heated by the heat generating resistor;
a temperature detector configured to detect a temperature of the fixing belt at a plurality of positions along a width of the belt corresponding to the longitudinal direction; and
a fixing controller configured to:
select a heat generating region corresponding to a portion of the heat generating resistor between adjacent electrodes on the base member, the heat generating region being selected according to a sheet size being processed in the image forming apparatus;
control the switch to supply power to the portion of the heat generating resistor corresponding to the heat generating region; and
by use of the voltage adjuster, increase the voltage applied to electrodes for the portion of the heat generating resistor when the temperature detector detects a temperature in the heat generating region is equal to or less than a threshold value, wherein
the first, second, and third electrodes are between the heat generating resistor and the base member.

17. The image forming apparatus according to claim 16, wherein
the heat generating resistor is between the surface protective layer and the base member.

18. The image forming apparatus according to claim 16, wherein
a distance between the first electrode and the second electrode is different from a distance between the second electrode and the third electrode.

19. The image forming apparatus according to claim 16, wherein
the heat generating resistor has a width between the first and second electrodes that is different from a width of the heat generating resistor between the second and third electrodes, the widths being dimensions in a direction perpendicular to the longitudinal direction.

20. The image forming apparatus according to claim 16, wherein
the heat generating resistor has a thickness between the first and second electrodes that is different from a thickness of the heat generating resistor between the second and third electrodes, the thicknesses being dimensions in a direction perpendicular to a surface of the base member.
